(19) United States
(12) Patent Application Publication
(10) Pub. No.: US 2004/0034147 A1
(43) Pub. Date: Feb. 19, 2004

(54) Hollow polymer particle, process for producing the same, paper coating composition using the same, coated paper and process for producing the same

(75) Inventor: Yoshiaki Zama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR CORPORATION, Tokyo (JP)

(21) Appl. No.: 10/216,842

(22) Filed: Aug. 13, 2002

(51) Int. Cl. C08F 2/16

(52) U.S. Cl. 524/460; 162/135

(57) ABSTRACT

An object of the present invention is to provide a hollow polymer particle having well-balanced properties such as gloss and coating strength, a process for producing the particle, a paper coating composition using the particle, and a coated paper. The hollow polymer particle can be obtained by emulsion-polymerizing monomers (a) comprising 5 to 80% by weight of an unsaturated carboxylic acid (a-1) and 20 to 95% by weight of a radical-polymerizable monomer (a-2) which can copolymerize with the unsaturated carboxylic acid (a-1), thereby preparing polymer particle (A); emulsion-polymerizing a part of 100 parts by weight of monomers (b) comprising 0 to 20% by weight of an unsaturated carboxylic acid (b-1) and 80 to 100% by weight of a radical-polymerizable monomer (b-2) which can copolymerize with the unsaturated carboxylic acid (b-1) in the presence of 5 to 1,000 parts by weight of the polymer particle (A), thereby preparing a core/shell type polymer particle (B) wherein the surface of the polymer particle (A) is covered with a shell layer comprising a polymer component obtained by polymerizing a part of the monomers (b) and an unreacted monomer component of the monomers (b); adjusting pH of the dispersed product containing the polymer particle (B) to 7 or more with a volatile base, thereby neutralizing and swelling the polymer particle (B); and subsequently polymerizing the unreacted monomer component.

### BACKGROUND OF THE INVENTION

1. Field of the Invention

The present invention relates to a hollow polymer particle, a process for producing the same, a paper coating composition using the same, a coated paper using the composition, and a process for producing the coated paper.

More specifically, the present invention relates to a process making it possible to effectively produce a hollow polymer particle which have well-balanced various properties such as masking property, gloss, coating strength, water resistance, alkali resistance, weather resistance and heat resistance and have an uniform particle size and a high volume percentage of hollowness, particularly a hollow polymer particle useful as a light scattering agent or a light scattering auxiliary in use for coating to paper, fiber, leather or the like, paint and the like.

Moreover, the present invention relates to a paper coating composition making it possible to give a coated paper having well-balanced properties such as whiteness, opacity, gloss, coating strength, printing gloss, and low speckle property, further, masking property, gloss, water resistance, alkali resistance, weather resistance and heat resistance, a coated paper using the composition, and a process for producing the coated paper.

2. Description of the Related Art

Hitherto, in the fields of coating to paper, fiber, leather or the like, the field of paint and the like fields, a hollow polymer particle, that is, a polymer particle having a single closed hole therein, has widely been used, for example, as an organic microcapsule particle wherein the hole is filled with various substances, or an organic light scattering agent or an organic light scattering auxiliary using light scattering property generated by making a particle hollow.

As a process for producing such a hollow polymer particle, for example, the following process is disclosed (in JP-A-56-32513 and JP-A-63-213509): a process of preparing a particle each of which has a core obtained by emulsion-polymerizing a monomer system containing at least one carboxylic acid group and a shell obtained by polymerizing another monomer system (which contains at least one monomer making it possible to produce a hard polymer which has a Tg over 25° C., forms no coating at 20° C., and can infiltrate in ammonia or amine), neutralizing the core with ammonia or amine so as to be swelled, and further drying a resultant polymer to form a single hollow inside the core.

According to the above-mentioned process, it is troublesome and difficult to control conditions for forming the hollow inside the core and it is also difficult to produce a polymer particle having a desired hollow with a high yield. About the particle produced by the process, in various properties required in the fields of coating, paint and the like, masking property, gloss, coating strength, whiteness and the like are improved to some extent. However, the balance of chiefly-requested properties (masking property, gloss, coating strength, whiteness, water resistance, alkali resistance, weather resistance, heat resistance, and the like) cannot be sufficiently satisfied. Even if the neutralization and swelling of the core with ammonia or amine are not performed at a temperature higher than Tg of the polymer constituting the shell, a sufficient volume percentage of hollowness cannot be obtained. Thus, in the production process, condition of high-temperature and high-pressure is required. It is therefore difficult to cause the shell to have a high Tg and a high molecular weight and be crosslinked. The polymer particle obtained by the above-mentioned process has drawbacks that they are not suitable for uses requiring resistances against mechanical pressure and impact, and uses requiring heat resistance, oil resistance and chemical resistance.

In addition, it cannot be said that a paper coating composition using such a hollow polymer particle has a sufficient performance. Even a hollow polymer particle having a low volume percentage of hollowness shows some improvement in masking property, gloss, coating strength, whiteness, and the like if the content of the particles is made large. However, if the content exceeds a certain value, various properties such as masking property, gloss, coating strength and whiteness falls. On the other hand, if the content is relatively lowered, no improvement is obtained.

### SUMMARY OF THE INVENTION

In light of the above-mentioned problems, the present invention has been made. An object of the present invention is to provide a hollow polymer particle having well-balanced various properties such as masking property, gloss, coating strength, water resistance, alkali resistance, weather resistance, heat resistance, oil resistance and chemical resistance and having an uniform particle size and a high volume percentage of hollowness, particularly a hollow polymer particle useful as a light scattering agent or a light scattering auxiliary in uses for coating to paper, fiber, leather or the like, and for paint. Another object of the present invention is to provide a process for producing a hollow polymer particle effectively at a normal pressure and a relatively low temperature.

Other objects of the present invention are to provide a paper coating composition for producing coated paper having well-balanced various properties such as whiteness, opacity, gloss, coating strength, low speckle property, and further having good masking property, water resistance, alkali resistance, weather resistance, oil resistance, chemical resistance and the like, coated paper using the paper coating composition, and a process for producing the coated paper.

The present invention is described as follows.

1. A process for producing a hollow polymer particle, comprising:

a step of emulsion-polymerization, polymerizing monomers (a) comprising 5 to 80% by weight of an unsaturated carboxylic acid (a-1) and 20 to 95% by weight of a radical-polymerizable monomer (a-2) which can copolymerize with the above-mentioned unsaturated carboxylic acid (a-1) (provided that total amount of the above-mentioned (a-1) and the above-mentioned (a-2) is set to 100% by weight), thereby preparing a polymer particle (A),

a step of emulsion-polymerization, polymerizing a part of 100 parts by weight of monomers (b) comprising 0 to 20% by weight of an unsaturated carboxylic acid (b-1) and 80 to 100% by weight of a radical-polymerizable monomer (b-2) which can copolymerize with the above-mentioned unsaturated carboxylic acid (b-1) (provided that the total amount of the above-mentioned (b-1) and the above-mentioned (b-2) is set to 100% by weight) in the presence of 5 to 1,000 parts by weight of the above-mentioned polymer particle (A), thereby preparing a core/shell type polymer particle (B) wherein the surface of the above-mentioned polymer particle (A) is covered with a shell layer comprising a polymer component obtained by polymerizing a part of the above-mentioned monomers (b) and an unreacted monomer component of the above-mentioned monomers (b),

a step of adjusting pH of the dispersed product containing the above-mentioned polymer particle (B) to 7 or more with a volatile base, thereby neutralizing and swelling the above-mentioned polymer particle (B), and

a step of polymerizing the above-mentioned unreacted monomer component.

2. The process for producing a hollow polymer particle according to 1 above, wherein the weight ratio of the above-mentioned polymer component to the above-mentioned unreacted monomer component in the above-mentioned shell layer is from 99/1 to 50/50.

3. The process for producing a hollow polymer particle according to 1 above, wherein the above-mentioned shell layer is produced by charging a part or all of the above-mentioned monomers (b) which will be the above-mentioned polymer component collectively at first and then emulsion-polymerizing the charged monomers.

4. The process for producing a hollow polymer particle according to 3 above, wherein 50% or more by weight of the above-mentioned collectively-charged monomers (b) based on 100% by weight of the total of the above-mentioned monomers (b) is an unsaturated carboxylic acid ester and/or an ethylenic aromatic compound.

5. The process for producing a hollow polymer particle according to 3 above, wherein the weight ratio of the above-mentioned collectively-charged monomers (b) to the above-mentioned polymer particle (A) is from 10/1 to 1/10.

6. The process for producing a hollow polymer particle according to 1 above, wherein the above-mentioned radical-polymerizable monomer (b-2) comprises a crosslinkable radical-polymerizable monomer, and the content of the above-mentioned crosslinkable radical polymerizable monomer is 50% or less by weight based on 100% by weight of the total of the above-mentioned radical-polymerizable monomer (b-2).

7. The process for producing a hollow polymer particle according to 1 above, wherein temperature of the above-mentioned dispersed product when the above-mentioned polymer particle (B) is neutralized and swelled is set to not more than the glass transition temperature (Tg) of the above-mentioned polymer component.

8. The process for producing a hollow polymer particle according to 1 above, wherein when the above-mentioned emulsion-polymerization is carried out by polymerizing only the above-mentioned radical-polymerizable monomer (b-2), and polymerizing the rest of the above-mentioned radical-polymerizable monomer (b-2) and the above-mentioned unsaturated carboxylic acid (b-1) after the completion of polymerization of 10 to 35% by weight of the above-mentioned monomers (b-2).

9. A hollow polymer particle produced by a process according to 1 above.

10. The hollow polymer particle according to 9 above, wherein volume percentage of hollowness is 50 to 99%.

11. A paper coating composition, comprising 0.1 to 100 parts by weight of the hollow polymer particle (X) according to 9 above, and 0 to 99.9% by weight of a pigment (Z) and/or a binder (Y) based on 100% by weight of the total amount of the above-mentioned (X), (Y) and (Z).

12. The paper coating composition according to 11 above, wherein volume percentage of hollowness of the above-mentioned hollow polymer particle (X) is 50 to 99%.

13. A paper coating composition, comprising a hollow polymer particle having a volume percentage of hollowness of 50 to 99% and an average particle size of 300 to 5,000 nm.

14. The paper coating composition according to 14 above, wherein thickness of shell of the above-mentioned hollow polymer particle is 30 to 200 nm.

15. The paper coating composition according to 13 above, wherein the above-mentioned hollow polymer particle is the hollow particle according to 9 above.

16. The paper coating composition according to 13 above, comprising 0.5 to 99.5% by weight of the above-mentioned hollow polymer particle, 0.5 to 99.5% by weight of a binder, and 0 to 99% by weight of a pigment and/or a thickener in terms of solid content based on 100% by weight of the total components.

17. A coated paper comprising a base paper and a coating which is formed on a single surface or both surfaces of the above-mentioned base paper and comprised of a hollow polymer particle and a binder, which is characterized in that volume percentage of hollowness of the above-mentioned hollow polymer particle is 50 to 99% and an average particle size of 300 to 5,000 nm.

18. A process for producing a coated paper characterized in coating the paper coating composition according to 13 above to a base paper in the manner that the coating amount of the above-mentioned composition is 0.3 to 30 g/m² after drying the composition.

The present invention can provide a process making it possible to effectively produce a hollow polymer particle which is excellent in coating property, have well-balanced coat properties such as masking property, whiteness, opacity, gloss, coating strength, water resistance, alkali resistance, weather resistance, heat resistance and chemical resistance, and have an uniform particle size and a high volume percentage of hollowness, particularly a hollow polymer particle useful as a light scattering agent or a light scattering auxiliary in uses for coating to paper, fiber, leather or the like, and for paint and the like.

The hollow polymer particle of the present invention is useful for various uses other than the above, for example, paint, ink, an agent for treating fiber or leather, absorbing fillers for inkjet paper, fillers in a papermaking process, highly-masking pigments for erasing ink or erasing ribbon, a raw material for microcapsules, and an intermediate materials for toner used in electrophotography.

The hollow polymer particle of the present invention is also useful for products using a heat insulating property on the basis of air, for example, a heat insulating layer as an undercoat of a thermosensitive layer in thermosensitive printer paper, thermal transfer printer paper or thermosensitive paper, or are useful as additives for products which are made light by use of air, for example, resin, cement, and concrete.

Furthermore, the hollow polymer particle of the present invention may be added to a semiconductor sealing material or the like in order to use a low dielectric property of air.

Since the paper coating composition of the present invention comprises a hollow polymer particle having a volume percentage of hollowness and an average particle size within the prescribed ranges, it is possible to give a coated paper having well-balanced printing properties such as whiteness, opacity, gloss, coating strength and printing gloss.

In the case of comprising a binder at a prescribed ratio, the paper coating composition can give a coated paper having better surface strength, opacity, white gloss and the like.

In the case of comprising a pigment or other additives, the paper coating composition can give a coated paper having better printing properties such as whiteness, opacity, gloss, coating strength and printing gloss.

In the case of using a hollow polymer particle is produced according to the prescribed process, a volume percentage of hollowness of the hollow polymer particle can be made larger.

By using the above-mentioned paper coating composition so as to be applied at the prescribed coating amount, coated paper having better performance can be obtained.

In the case of coating by a non-contact coating method, a coated paper having better performance can be obtained.

### DETAILED DESCRIPTION OF THE INVENTION

The present invention will be specifically described hereinafter.

1. Process for Producing Hollow Polymer Particle

The hollow polymer particle of the present invention can be produced according to the following process:

a step of emulsion-polymerization, polymerizing specific monomers (a) to a polymer particle (A),

a step of preparing a core/shell type polymer particle (B) wherein the surface of the polymer particle (A) is covered with a shell layer comprising a polymer component obtained by polymerizing specific monomers (b) and an unreacted monomer component of the monomers (b),

a step of adjusting pH of the dispersed product containing the polymer particle (B) to 7 or more with a volatile base, thereby neutralizing and swelling the polymer particle(B), and

a step of polymerizing the unreacted monomer component to a resultant hollow polymer particle (X).

Each of the steps in the above-mentioned process will be specifically described hereinafter.

(1) Preparation of Polymer Particle (A)

First, monomers (a) comprising an unsaturated carboxylic acid (a-1) (hereinafter, referred to as “monomer (a-1)”) and a radical-polymerizable monomer (a-2) (hereinafter, referred to as a “monomer (a-2)”) which can copolymerize with the monomer (a-1), so as to prepare the captioned polymer particle (A). The kind of the disperse medium used at this time is not particularly limited. Usually, an aqueous medium is used.

This aqueous medium is usually water. It is allowable to use a medium wherein a water-soluble organic solvent (for example, ethanol, methanol, acetone or the like) is added to water.

Examples of the monomer (a-1) include mono- or di-carboxylic acids such as (meth)acrylic acid, crotonic acid, maleic acid, fumaric acid and itaconic acid, and anhydrides of the dicarboxylic acids and the like. From the viewpoint of stability of particle, (meth)acrylic acid and itaconic acid are preferred. (Meth)acrylic acid is more preferred. These may be used alone or in combination of two or more.

Examples of the monomer (a-2) include unsaturated carboxylic acid esters, and ethylenic aromatic compounds, and other non-crosslinkable radical-polymerizable monomers. These may be used alone or in combination of two or more. Among these compounds, the unsaturated carboxylic acid esters are preferred. It is preferable that 50% or more by weight of the monomer (a-2) contains unsaturated carboxylic acid esters. If the monomer (a-2) contains less than 50% by weight of the unsaturated carboxylic acid esters, the shape of a resultant hollow polymer particle becomes distorted and a volume percentage of hollowness is reduced.

Examples of the unsaturated carboxylic acid esters include methyl (meth)acrylate, ethyl (meth)acrylate, propyl (meth)acrylate, butyl (meth)acrylate, 2-ethylhexyl (meth)acrylate and the like. These may be used alone or in combination of two or more.

Examples of the ethylenic aromatic compounds include styrene, α-methylstyrene and the like. These may be used alone or in combination of two or more.

Examples of the other non-crosslinkable radical-polymerizable monomers include (meth)acrylonitrile, vinyl acetate, N,N-dimethyl(meth)acrylamide and the like. These may be used alone or in combination of two or more.

As a part of the monomer (a-2), a crosslinkable monomer can be used. Examples of the crosslinkable monomer include butadiene, isoprene, divinylbenzene, ethylene glycol di(meth)acrylate and the like. These may be used alone or in combination of two or more. The amount of the crosslinkable monomer to be charged is preferably 5% or less by weight of the total amount of the monomers (a), and is more preferably 0.2 to 2% by weight. If the amount of the crosslinkable monomer is more than 5% by weight, the swelling by a volatile base is insufficient so that a volume percentage of hollowness becomes low. As a result, properties such as masking property, whiteness and gloss unfavorably become insufficient.

The respective amounts of the monomer (a-1) and the monomer (a-2) in the monomers (a) to be charged are as follows: the amounts of the monomer (a-1) and the monomer (a-2) are 5 to 80% by weight and 20 to 95% by weight, respectively, preferably 10 to 60% by weight and 40 to 90% by weight, respectively, and more preferably 20 to 50% by weight and 50 to 80% by weight, respectively, provided that total amount of the monomer (a-1) and the monomer (a-2) is set to 100% by weight).

If the amount of the monomer (a-1) is less than 5% by weight, the swelling by a volatile base is insufficient so that a volume percentage of hollowness becomes low. As a result, properties such as masking property, whiteness and gloss unfavorably become insufficient. On the other hand, if the amount of the monomer (a-1) is more than 80% by weight, the polymerization stability of the monomers (a) deteriorates. As a result, it becomes difficult that the surface layer is uniformly covered with the polymer obtained from the monomers (b). Thus, the shape of a resultant hollow polymer particle unfavorably becomes distorted.

The method of emulsion-polymerizing the monomers (a) in the disperse medium is not particularly limited. For example, the monomers may be collectively added and polymerized. Alternatively, the monomers may be continuously added and polymerized. In order to obtain a particle having an uniform particle size stably, the latter is preferable. The preparation of the polymer particle (A) may be performed by polymerization at a single step or multiple polymerization at two or more steps. The monomers (a) may be subjected to seed emulsion polymerization in the presence of a seed particle. In order to obtain a particle having an uniform particle size stably, the seed particle is preferably a particle which SP value (solubility parameter) of polymer constituting the seed particle is close to that of the monomers (a).

An emulsifier may be used in emulsion-polymerization of the monomers (a). Examples of the emulsifier include anionic surfactants, nonionic surfactants, cationic surfactants, amphotelic surfactants, organic suspension protective agents and the like. From the viewpoint of the stability of particle, anionic surfactants, nonionic surfactants and organic suspension protective agents are preferred. These emulsifiers may be used alone or in combination of two or more.

Examples of the anionic surfactant include rosin acid salts such as potassium salt of rosin acid and sodium salt of rosin acid, sodium or potassium salts of aliphatic acids such as potassium oleate, potassium laurate, sodium laurate, sodium stearate and potassium stearate, sulfates of aliphatic alcohols such as sodium laurylsulfate, alkylallylsulfonic acid such as sodium dodecylbenzenesulfonate, and the like. These anionic surfactants may be used alone or in combination of two or more.

Examples of the nonionic surfactant include alkyl esters, alkyl ethers, alkyl phenyl ethers of polyethylene glycol and the like. These nonionic surfactants may be used alone or in combination of two or more.

Examples of the organic suspension protective agent include hydrophilic synthetic macromolecular materials such as polyacrylic acid, polymethacrylic acid, polyvinyl sulfonate, polyvinyl alcohol, polyvinyl pyrrolidone and polyethylene glycol, natural hydrophilic macromolecular materials such as gelatin and water-soluble starch, hydrophilic semisynthetic macromolecular materials such as carboxymethylcellulose and the like. These organic suspension protective agents may be used alone or in combination of two or more.

Examples of the cationic surfactant include aliphatic amine salts, aliphatic quaternary ammonium salts and the like. These may be used alone or in combination of two or more.

Examples of the ampholytic surfactant include carboxy betaine type surfactants, aminocarboxylic acid salts and the like.

Examples of a polymerization initiator used in the emulsion-polymerization of the monomers (a) include:

(i) redox initiators, for example, any combination of an organic hydroperoxide such as cumene hydroperoxide, diisopropylbenezene hydroperoxide, paramenthane hydroperoxide and t-butyl hydroperoxide, and a reducing agent such as sugar-containing pyrophosphoric acid formulations, sulfoxylate formulations, mixed formulations of a sugar-containing pyrophosphoric acid formulation, a sulfoxylate formulation, and formaldehyde resin formulations,

(ii) persulfates such as potassium persulfate and ammonium persulfate,

(iii) azobisisobutyronitrile,

(iv) organic hydroperoxides such as benzoyl peroxide and lauroyl peroxide, and the like.

From the viewpoints of the stability of a particle and the uniformity of particle size, persulfates such as potassium persulfate and ammonium persulfate, azobisisobutyronitrile and benzoyl peroxide are preferred.

The polymerization temperature in polymerizing the monomers (a) is preferably 5 to 95° C., more preferably 50 to 90° C. If the polymerization temperature is less than 5° C., the reactivity of the unsaturated carboxylic acid is low so that a resultant particle may become unstable. On the other hand, if the temperature is more than 95° C., a particle may become unstable.

A resultant polymer particle (A) will be an alkali-swelling core particle. The average particle size of the polymer particle (A) is preferably 0.1 to 2 μm, more preferably from 0.2 to 2 μm.

(2) Preparation of Polymer Particle (B)

A polymer particle (B) is prepared by emulsion-polymerizing one hundred parts by weight of monomers (b) in the presence of 5 to 1,000 parts by weight, preferably 7 to 100 parts by weight and more preferably 10 to 50 parts by weight of the polymer particle (A) and is a core/shell type polymer particle wherein the surface of the polymer particle (A) is covered with a shell layer comprising a polymer component obtained by polymerizing a part of the monomers (b) and an unreacted monomer component of the monomers (b).

If the amount of the polymer particle (A) is less than 5 parts by weight, the formation of hollow in a resultant hollow polymer particle (X), which becomes insufficient and leads to an inferior in masking property, whiteness, gloss and the like when forming a coating. On the other hand, if the amount of the polymer particle (A) is more than 1,000 parts by weight, polymerization stability deteriorates. Moreover, the polymer particle subjected to a volatile base treatment and a heating treatment are ruptured and deformed to be broken. As a result, a volume percentage of hollowness reduced.

The monomers (b) comprise an unsaturated carboxylic acid (b-1) (hereinafter, referred to as a “monomer (b-1)”) and a radical-polymerizable monomer (b-2) (hereinafter, referred to as a “monomer (b-2)”) which can copolymerize with the monomer (b-1).

Examples of the monomer (b-1) include mono- or di-carboxylic acids such as (meth)acrylic acid, crotonic acid, maleic acid, fumaric acid and itaconic acid, anhydrides of the dicarboxylic acids and the like. From the viewpoint of the stability of particle, (meth)acrylic acid and itaconic acid are preferred. (Meth)acrylic acid is more preferred. These may be used alone or in combination of two or more.

Examples of the monomer (b-2) include unsaturated carboxylic acid esters, ethylenic aromatic compounds and other non-crosslinkable radical-polymerizable monomers. These may be used alone or in combination of two or more. Among these compounds, the ethylenic aromatic compounds are preferred. It is preferable that 50% or more by weight of the monomer (b-2) contains ethylenic aromatic compound such as styrene. If the monomer (b-2) contains less than 50% by weight of the ethylenic aromatic compound, the refractive index of the polymer drops so that whiteness, opacity and gloss may be insufficient.

Examples of the unsaturated carboxylic acid esters include methyl (meth)acrylate, ethyl (meth)acrylate, propyl (meth)acrylate, butyl (meth)acrylate, 2-ethylhexyl (meth)acrylate and the like. These may be used alone or in combination of two or more.

Examples of the ethylenic aromatic compound include styrene, α-methylstyrene and the like. These may be used alone or in combination of two or more.

Examples of the other non-crosslinkable radical-polymerizable monomers include (meth)acrylonitrile, vinyl acetate, N,N-dimethyl(meth)acrylamide and the like. These may be used alone or in combination of two or more.

The monomer (b-2) may contain a crosslinkable radical-polymerizable monomer. This makes it possible to keep the shape of a resultant hollow particle against heat, mechanical stress, swelling based on a solvent or a chemical, discomposition, or the like. Examples of the crosslinkable radical-polymerizable monomer include divinylbenzene, trivinylbenzene, dicyclopentadiene, butadiene, isoprene, allyl glycidyl ether, glycidyl (meth)acrylate, ethylene glycol di(meth)acrylate and the like. Divinylbenzene and ethylene glycol di(meth)acrylate are particularly preferred. These may be used alone or in combination of two or more.

In the case of using the crosslinkable radical-polymerizable monomer, the amount of the monomer to be charged is preferably 50% or less by weight, and is more preferably 0.1 to 30% by weight based on the total amount of the monomer (b-2). If the amount of the crosslinkable radical-polymerizable monomer is more than 50% by weight, a volume percentage of hollowness unfavorably becomes insufficient. And the amount of the monomer to be charged is preferably 20 parts or less by weight, more preferably 0.1 to 10 parts by weight based on 100% by weight of the total amount of the monomers (b).

The respective amounts of the monomer (b-1) and the monomer (b-2) in the monomers (b) to be charged are as follows: the amounts of the monomer (b-1) and the monomer (b-2) are 0 to 20% by weight and 80 to 100% by weight, respectively, preferably 0.1 to 10% by weight and 90 to 99.9% by weight, respectively, and more preferably 0.2 to 5% by weight and 95 to 99.8% by weight, respectively, provided that total amount of the monomer (b-1) and the monomer (b-2) is set to 100% by weight.

If the amount of the monomer (b-1) is more than 20%, the polymerization stability deteriorates. Moreover, a resultant hollow polymer particle subjected to a volatile base treatment and a heating treatment is distorted and a volume percentage of hollowness is reduced.

The method of emulsion-polymerizing the monomers (b) is not particularly limited. The same method as in the case of the polymer particle (A) can be used.

In order to make a covering structure of the shell complete, it is preferable that a part or all of the monomers (b) to be formed a polymer component are collectively charged at first and the charged monomers are emulsion-polymerized in the presence of the polymer (A). At this time, the weight ratio of the collectively-charged monomers (b) to the polymer particle (A) is preferably 10/1 to 1/10, more preferably 5/1 to 1/5. If the ratio is more than 10/1, the stability is insufficient. If the ratio is less than 1/10, the covering to the polymer particle (A) is insufficient and a resultant hollow polymer particle is distorted. Thus, a volume percentage of hollowness is reduced.

It is particularly preferred that the monomers (b) collectively charged at first are ethylenic aromatic compounds such as styrene, and unsaturated carboxylic acid esters such as methyl (meth)acrylate.

In order to make a volume percentage of hollowness of the hollow polymer particle high, it is preferred to polymerize only the radical-polymerizable monomer (b-2) firstly, and the rest of said radical-polymerizable monomer (b-2) and said unsaturated carboxylic acid (b-1) after the completion of polymerization of usually 10 to 35% by weight, preferably 20 to 30% by weight of the monomer (b-2).

The weight ratio of the polymer component obtained by polymerizing the monomers (b) to the unreacted monomer component in the shell layer of the polymer particle (B) is preferably 99/1 to 50/50, more preferably 97/3 to 80/20, provided that total amount of the polymer component and the unreacted monomer is set to 100 by weight. If the weight of the polymer component is more than 99, it is unfavorably necessary to raise the temperature at the time of the neutralization with a volatile base in order to raise a volume percentage of hollowness. Furthermore, if the weight of the polymer component is 50 or less, the temperature and pH during the neutralization and the swelling are not easily controlled. Thus, unfavorably, a resultant hollow polymer particle is distorted.

The glass transition temperature (Tg) of a polymer constituting the shell layer of the polymer particle (B) is 50° C. or more, preferably 70° C. or more, and more preferably 100° C. or more, from the viewpoint of improvement in whiteness, opacity and gloss. The particle size of the polymer particle (B) is preferably 0.15 to 4 μm, more preferably 0.25 to 3 μm.

(3) Preparation of a Hollow Polymer Particle (X)

A hollow polymer particle (X) in which an aqueous medium is filled (water-containing particle) is prepared by adjusting pH of the dispersed product containing the core/shell type polymer (B) to 7 or more with a volatile base such as ammonia and amine so that the polymer particle is neutralized and swelled, heating it as necessary, finally polymerizing the unreacted monomer component.

The temperature of the dispersed product when the polymer particle (B) is neutralized and swelled, which depends on the amount of the unreacted monomer component in the shell layer of the polymer particle (B), is preferably not more than the glass transition temperature (Tg) of the above-mentioned polymer component constituting the shell layer of the polymer particle (B). If the neutralization and the swelling are performed at a temperature over Tg, the core may break through the shell so as to pierce outside.

Since the polymer component obtained by polymerizing the monomers (b) is a component into which the volatile base can infiltrate, the component constituting the polymer particle (A) is neutralized by the infiltration of the volatile base. Following this, the components constituting the polymer particle (A) absorbs water markedly.

After the polymer particle (B) is swelled, the unreacted monomer component present in the shell layer is polymerized to yield a water-containing particle. The concentration of the monomer remaining after the polymerization of the unreacted monomer component in the dispersed product is preferably 3,000 ppm or less, more preferably 1,000 ppm or less, and most preferably 300 ppm or less. If the monomer remains at a level over 3,000 ppm in the dispersed product, the rigidity of the shell of the hollow polymer particle (X) is insufficient. As a result, unfavorably, the hollow polymer particle (X) is easily distorted.

In order to polymerize the unreacted monomer component in the shell layer of the neutralized and swelled polymer particle (B), it is allowable to add a polymerization initiator, a polymerization initiation auxiliary, a reducing agent or the like.

Examples of a polymerization initiator include:

(i) redox initiators, for example, any combination of an organic hydroperoxide such as cumene hydroperoxide, diisopropylbenezene hydroperoxide, paramenthane hydroperoxide and t-butyl hydroperoxide, and a reducing agent such as sugar-containing pyrophosphoric acid formulations, sulfoxylate formulations, mixed formulations of a sugar-containing pyrophosphoric acid formulation, a sulfoxylate formulation, and formaldehyde resin formulations,

(ii) persulfates such as potassium persulfate and ammonium persulfate,

(iii) azobisisobutyronitrile,

(iv) organic hydroperoxides such as benzoyl peroxide and lauroyl peroxide, and the like.

From the viewpoint of the high reactivity, a system wherein t-butyl hydroperoxide is combined with formaldehyde resin is preferred.

After the neutralization and the swelling of the polymer particle (B), a radical-polymerizable monomer may be newly added thereto so as to be polymerized. In this way, a resultant polymer can be made into a part of the shell of the hollow polymer particle (X). In this case, the above-mentioned polymerization initiator and the like are preferably added together.

The method of drying the generated water-containing particle so as to be made up to a hollow particle is not particularly limited. Examples of drying method include a spray drying method at a temperature of 135 to 155° C., a tray drying method using a hot wind drier at a temperature of 50 to 70° C., a fluid bed drying method at a temperature of 15 to 70° C., and the like.

According to the present invention, a hollow polymer particle (X) having a particle size of 0.2 to 8 μm, a single hollow, and a volume volume percentage of hollowness of 20 to 99%, preferably 50 to 99%, more preferably 51 to 99%, still more preferably 56 to 99%, still more and more preferably 60 to 99%, particularly preferably 63 to 98%, particularly more preferably 65 to 98%, particularly still more preferably 68 to 98%, and most preferably 70 to 98% can be produced. Preferably, a hollow polymer particle (X) having a particle size of 300 to 5,000 nm, a single hollow, and a volume percentage hollowness of 60 to 99% can be produced by the above-mentioned process.

Furthermore, a hollow polymer particle having a volume volume percentage of hollowness of 56 to 99%, preferably 60 to 99%, more preferably 63 to 98%, still more preferably 65 to 98% and still more and more preferably 68 to 98%, and a shell thickness of 20 to 220 nm, preferably 20 to 190 nm, more preferably 30 to 180 nm and still more preferably 30 to 150 nm can be produced. A hollow polymer particle having a high volume volume percentage of hollowness and a thin shell thickness can be obtained.

In the case of applying to a paper coating composition, a resultant water-containing particle itself may be into the paper coating composition without being dried. The water-containing particle may be dried to volatilize the aqueous medium which is a disperse medium, and the dried particle may be used as a powdery hollow particle, from inside of which the aqueous medium is also volatized. When a paper coating composition containing a water-containing particle is used, an aqueous medium volatilizes during drying the coating and a hollow hole forms.

2. Paper Coating Composition and Coating Composition

(1) Paper Coating Composition of the First Aspect of the Invention

The paper coating composition of the first aspect of the invention comprises a hollow polymer particle (X) produced by the above-mentioned process. Hereinafter, the hollow polymer particle according to the first aspect of the invention is referred to as the “hollow polymer particle (X1)”.

The volume percentage of hollowness of the hollow polymer particle (X1) according to the first aspect of the present invention is 20 to 99%, preferably 50 to 99%, more preferably 51 to 99%, still more preferably 56 to 99%, still more and more preferably 60 to 99%, particularly preferably 63 to 98%, particularly more preferably 65 to 98%, particularly still more preferably 68 to 98% and most preferably 70 to 98%. The volume percentage of hollowness of less than 20% of leads to an insufficient opacity, whiteness, gloss and the like. On the other hand, if the volume percentage of hollowness is more than 99%, a mechanical stability reduces so that a particle is deformed or broken at the time of preparing a composition or coating the composition. The average particle size of the hollow polymer particle (X1) can be 200 to 8,000 nm, preferably 300 to 5,000 nm, more preferably 500 to 3,000 nm, and still more preferably 700 to 2,000 nm. If the average particle size is less than 200 nm, opacity, whiteness, gloss and the like deteriorate. On the other hand, if the average particle size is more than 8,000 nm, a mechanical stability deteriorates.

The thickness of the shell of the hollow polymer particle (X1) can be 20 to 220 nm, preferably 20 to 190 nm, more preferably 30 to 180 nm, and still more preferably 30 to 150 nm. This makes it possible to make the paper coating composition light. The hollow polymer particle may be used in the state that the hollow is filled with an aqueous medium such as water. The particle in this state is referred to as a water-containing particle hereinafter. Alternatively, the hollow polymer particle may be used in a dry hollow particle state, in which the water-containing particle is dried to remove water inside the particle. In the present specification and claims, the hollow polymer particle represent both of the water-containing particle and the dried hollow particle.

The content of the hollow polymer particle (X1) is 0.1 to 100% by weight, preferably 1 to 95% by weight, more preferably 3 to 50% by weight, most preferably 5 to 30% by weight based on 100% by weight of the total of the hollow polymer particle (X1), a binder (Y) and a pigment (Z). And the content of the hollow polymer particle (X1) is 0.1 to 100 parts by weight, preferably 1 to 90 parts by weight, more preferably 1 to 20 parts by weight based on 100 parts by weight of the total of the hollow polymer particle (X1) and the pigment (Z).

The composition of the present invention can be comprising a pigment (Z) and/or a binder (Y).

The binder (Y) is not particularly limited as long as it is used as a binder for paper coating and the like. Examples of the binder include natural binders such as starch, modified starch and casein, synthetic binders such as styrene-butadiene copolymers; modified styrene-butadiene copolymers exemplified carboxy-modified styrene-butadiene copolymer, amine-modified styrene-butadiene copolymer and hydroxyl group-modified styrene-butadiene copolymer, polyvinyl acetate, acrylic polymers, polychloroprene, polyvinyl alcohol, and modified acrylic copolymers exemplified carboxy-modified acrylic copolymer, amine-modified acrylic copolymers and hydroxyl group-modified acrylic copolymer. These binders may be used alone or in combination of two or more.

Among these, modified styrene-butadiene copolymer is preferable and carboxy-modified styrene-butadiene copolymer is particularly preferred by using alone or in combination of the natural binder such as starch or casein.

As the above-mentioned binders, binders contained as a solid content in latex may be used, or powdery binders may be used.

The content of the binder (Y) is preferably 1 to 50% by weight, more preferably 3 to 35% by weight based on 100% by weight of the total of the components (X1), (Y) and (Z). And the content of the binder (Y) is 1 to 50 parts by weight, preferably 5 to 30 parts by weight in terms of solid content based on 100 parts by weight of the total of the components (X1) and (Z).

Examples of the pigment (Z) include organic pigments and inorganic pigments. Examples of the inorganic pigments include kaolin clay, talc, barium sulfate, titanium oxide (rutile and anatase), calcium carbonate, aluminum hydroxide, zinc oxide and satin white. These may be used alone or in combination of two or more.

Examples of the organic pigment include styrene-based, styrene/butadiene-based and styrene/acrylic component-based pigments, solid plastic pigments, urea resin particle and the like. These may be used alone or in combination of two or more.

The content of the pigment (Z) is preferably 1 to 95% by weight, more preferably 60 to 85% by weight based on 100% by weight of the total of the components (X1), (Y) and (Z). And the content (Z) of the pigment (Z) is 50 to 99 parts by weight, preferably 70 to 90 parts by weight based on 100% by weight of the total of the components (X1) and (Z).

The composition of the present invention comprises [1] 0.1 to 100% by weight of the hollow polymer particle (X1) and 0 to 99.9% by weight of the pigment (Z) and/or the binder (Y), preferably [2] 1 to 95% by weight of the hollow polymer particle (X1) and 5 to 99% by weight of the pigment (Z) and/or the binder (Y), more preferably [3] 3 to 50% by weight of the hollow polymer particle (X1) and 50 to 93% by weight of the pigment (Z) and/or the binder (Y), and still more preferably [4] 5 to 30% by weight of the hollow polymer particle (X1) and 70 to 95% by weight of the pigment (Z) and/or the binder (Y) based on 100% by weight of the total of the components (X1), (Y) and (Z). If the content of the hollow polymer particle (X1) is less than 0.1% by weight, properties such as whiteness, opacity and gloss become insufficient.

In the case of the above-mentioned [1], the contents of the pigment (Z) and the binder (Y) are 0 to 99.9% by weight and 0 to 98.9% by weight, respectively. In the case of the above-mentioned [2], the contents of the pigment (Z) and the binder (Y) are 3 to 97% by weight and 2 to 96% by weight, respectively. In the case of the above-mentioned [3], the contents of the pigment (Z) and the binder (Y) are 47 to 85% by weight and 3 to 37% by weight, respectively. In the case of the above-mentioned [4], the contents of the pigment (Z) and the binder (Y) are 60 to 85% by weight and 10 to 25% by weight, respectively.

Various additives may be added to the composition of the present invention as necessary. Examples of the additives include a thickener, a dispersing agent, an antifoaming agent, a waterproof agent, a lubricant and the like.

Examples of the thickener (W) include starch, casein, carboxy-modified cellulose, an acrylic alkali thickener. These may be used alone or in combination of two or more. The amount of the thickener (W) to be incorporated is preferably 3% or less by weight, preferably 0.05 to 2% by weight, more preferably 0.05 to 1% by weight based on 100% by weight of the total of the hollow polymer particle (X1), the binder (Y), the pigment (Z) and the thickener (W). And the amount of the thickener is preferably 5 parts or less by weight, more preferably 0.5 part or less by weight, most preferably 0.05 to 0.2 part by weight based on 100 parts by weight of the total of the hollow polymer particle (X1) and the pigment (Z).

Examples of the dispersing agent include sodium pyrophosphate, sodium hexametaphosphate, sodium polycarboxylate and the like. These may be used alone or in combination of two or more. The amount of the dispersing agent to be incorporated is preferably 0.01 to 2 parts by weight, more preferably 0.05 to 1 parts by weight based on 100 parts by weight of the total of the hollow polymer particle (X1) and the pigment (Z) in terms of solid content.

Examples of the lubricant include higher aliphatic acid salts such as calcium stearate, calcium palmitate and calcium oleate, polyethylene wax and the like. These may be used alone or in combination of two or more. The amount of the lubricant to be incorporated is preferably 0.01 to 2 parts by weight, more preferably 0.05 to 1 parts by weight based on 100 parts by weight of the total of the hollow polymer particle (X1) and the pigment (Z) in terms of solid content.

Examples of the antifoaming agent include polyglycol aliphatic acid esters, phosphoric esters (phosphates), silicone oils and the like. These may be used alone or in combination of two or more. The amount of the antifoaming agent to be incorporated is preferably 0.01 to 2 parts by weight, more preferably 0.05 to 1 parts by weight based on 100 parts by weight of the total of the hollow polymer particle (X1) and the pigment (Z) in terms of solid content.

Performances of the coated paper produced using the composition of the first aspect of the present invention under conditions described in Examples can be shown as follows: gloss; 70 to 83, opacity; 88 to 95, heat resistance; 0.1 to 5, and whiteness; 80 to 87.

In the case of using a composition whose contents of the hollow polymer particle (X1), the pigment (Z) and the binder (Y) are 5 to 30% by weight, 60 to 85% by weight and 10 to 25% by weight, respectively based on 100% by weight of the total of the components (X1), (Z) and (Y), performances of the coated paper produced can be shown as follows: gloss; 70 to 83, opacity; 88 to 95, heat resistance; 0.1 to 5, and whiteness; 80 to 87.

(2) Paper Coating Composition of the Second Aspect of the Invention

The composition of the second aspect of the invention comprises a hollow polymer particle whose volume percentage of hollowness is 50 to 99%, preferably 51 to 99%, more preferably 56 to 99%, still more preferably 60 to 99%, still more and more preferably 63 to 98%, particularly preferably 65 to 98%, particularly more preferably 68 to 98%, and most preferably 70 to 98%. The above-mentioned hollow polymer particle is referred to as the “hollow polymer particle (X2)” hereinafter.

The average particle size of the hollow polymer particle (X2) can be 300 to 5,000 nm, preferably 500 to 3,000 nm, and more preferably 700 to 2,000 nm.

The thickness of the shell of the hollow polymer particle (X2) can be 20 to 220 nm, preferably 20 to 190 nm, more preferably 30 to 180 nm, and still more preferably 30 to 150 nm. This makes it possible to make the paper coating composition light. The hollow polymer particle (X2) may be used a water-containing particle or a dried hollow particle.

The material constituting the hollow polymer particle (X2) according to the second aspect of the invention is not particularly limited, but is preferably a copolymer obtained by polymerizing monomers (b) comprising the monomer (b-1) and the monomer (b-2), or a mixture of the above-mentioned copolymer and a polymer obtained by polymerizing the monomer (b-1) or the monomer (b-2).

Examples of the monomer (b-1) include mono- or di-carboxylic acids such as (meth)acrylic acid, crotonic acid, maleic acid, fumaric acid and itaconic acid, anhydrides of the dicarboxylic acids and the like. From the viewpoint of the stability of particle, (meth)acrylic acid and itaconic acid are preferred. (Meth)acrylic acid is more preferred. These may be used alone or in combination of two or more.

Examples of the monomer (b-2) include unsaturated carboxylic acid esters, ethylenic aromatic compounds and other non-crosslinkable radical-polymerizable monomers. These may be used alone or in combination of two or more. Among these compounds, the ethylenic aromatic compounds are preferred. It is preferable that 50% or more by weight of the, monomer (b-2) contains ethylenic aromatic compound such as styrene. If the monomer (b-2) contains less than 50% by weight of the ethylenic aromatic compound, the refractive index of the polymer drops so that whiteness, opacity and gloss may be insufficient.

Examples of the unsaturated carboxylic acid esters include methyl (meth)acrylate, ethyl (meth)acrylate, propyl (meth)acrylate, butyl (meth)acrylate, 2-ethylhexyl (meth)acrylate and the like. These may be used alone or in combination of two or more.

Examples of the ethylenic aromatic compound include styrene, α-methylstyrene and the like. These may be used alone or in combination of two or more.

Examples of the other non-crosslinkable radical-polymerizable monomers include (meth)acrylonitrile, vinyl acetate, N,N-dimethyl(meth)acrylamide and the like. These may be used alone or in combination of two or more.

The monomer (b-2) may contain a crosslinkable radical-polymerizable monomer. This makes it possible to keep the shape of a resultant hollow particle against heat, mechanical stress, swelling based on a solvent or a chemical, discomposition, or the like. Examples of the crosslinkable radical-polymerizable monomer include divinylbenzene, trivinylbenzene, dicyclopentadiene, butadiene, isoprene, allyl glycidyl ether, glycidyl (meth)acrylate, ethylene glycol di(meth)acrylate and the like. Divinylbenzene and ethylene glycol di(meth)acrylate are particularly preferred. These may be used alone or in combination of two or more.

In the case of using the crosslinkable radical-polymerizable monomer, the amount of the monomer to be charged is preferably 50% or less by weight, and is more preferably 0.1 to 30% by weight based on the total amount of the monomer (b-2). If the amount of the crosslinkable radical-polymerizable monomer is more than 50% by weight, a volume percentage of hollowness unfavorably becomes insufficient. And the amount of the monomer to be charged is preferably 20 parts or less by weight, more preferably 0.1 to 10 parts by weight based on 100% by weight of the total amount of the monomers (b).

The respective amounts of the monomer (b-1) and the monomer (b-2) in the monomers (b) to be charged are as follows: the amounts of the monomer (b-1) and the monomer (b-2) are 0 to 20% by weight and 80 to 100% by weight, respectively, preferably 0.1 to 10% by weight and 90 to 99.9% by weight, respectively, and more preferably 0.2 to 5% by weight and 95 to 99.8% by weight, respectively, provided that total amount of the monomer (b-1) and the monomer (b-2) is set to 100% by weight.

If the amount of the monomer (b-1) is more than 20%, the polymerization stability deteriorates. Moreover, a resultant hollow polymer particle subjected to a volatile base treatment and a heating treatment is distorted and a volume percentage of hollowness is reduced. The process for producing the hollow polymer particle (X2) is not particularly limited. For example, the process for producing the hollow polymer particle (X) in the above-mentioned item 1. can be used as a hollow polymer particle (X2).

The paper coating composition of the invention contains further a binder and a pigment and/or a thickener. The binder, the pigment and the thickener may be used as explained in the first aspect as it is. Hereinafter, the binder, the pigment and the thickener are referred to as the “binder (Y)”, the “pigment (Z)”, and the “thickener (W)”, respectively.

The content of the hollow polymer particle (X2) is 0.5 to 99.5% by weight, preferably 1 to 97% by weight, more preferably 3 to 95% by weight, most preferably 30 to 70% by weight based on 100% by weight of the total of the hollow polymer particle (X2), the binder (Y), the pigment (Z) and the thickener (W). If the content of the hollow polymer particle (X2) is less than 0.5% by weight, opacity, whiteness, gloss and the like unfavorably deteriorate. If the content is more than 99.5% by weight, the content of the binder (Y) becomes less than 0.5% so that the surface strength lacks. Problems of particle-drop, piling and the like arise. And the content of the hollow polymer particle (X2) is preferably 0.8 to 100% by weight, preferably from 20 to 100% by weight, more preferably from 25 to 90% by weight, most preferably 30 to 80% by weight based on 100% by weight of the total of the hollow polymer particle (X2) and the pigment (Z).

The amount of the binder (Y) to be incorporated is preferably 0.5 to 99.5% by weight, more preferably 1 to 99% by weight, still more preferably 2.5 to 97%, still more and more preferably 1 to 20%, most preferably 1 to 15% in terms of solid content based on 100% by weight of the total of the component (X2), (Y), (Z) and (W). If the amount is less than 0.5% by weight, the surface strength lacks so that problems of particle-drop, piling and the like may arise. If the amount is more than 99.5% by weight, the blend amount of the hollow polymer particle (X2) becomes less than 0.5% by weight so that properties such as opacity, whiteness and gloss unfavorably deteriorate.

The amount of the binder (Y) to be incorporated is preferably 1 to 99% by weight, more preferably 1 to 20% by weight, most preferably 2.5 to 18% by weight based on 100% by weight of the total of the components (X2) and (Z).

In addition, the amount of the pigment (Z) to be incorporated is preferably 99% or less by weight, more preferably 89% or less by weight, still more preferably 20 to 75% by weight, most preferably 30 to 65% by weight in terms of solid content based on 100% by weight of the total of the components (X2), (Y), (Z) and (W).

And the amount of the pigment (Z) to be incorporated is preferably 99.2% or less by weight, more preferably 80% or less by weight, still more preferably 10 to 75% by weight, most preferably 30 to 65% by weight based on 100% by weight of the total of the components (X2) and (Z).

The amount of the thickener (W) to be incorporated is preferably 3% or less by weight, more preferably 0.05 to 2% by weight, most preferably 0.05 to 1% by weight in terms of solid content based on 100% by weight of the total of the components (X2), (Y), (Z) and (W).

And the amount of the thickener (W) to be incorporated is preferably 5% or less by weight, more preferably 0.5% or less by weight, most preferably 0.05 to 2% by weight based on 100% by weight of the total of the components (X2) and (Z).

The composition of the present invention comprises [1] 0.5 to 99.5% by weight of the hollow polymer particle (X2), 0.5 to 99.5% by weight of the binder (Y), and 0 to 99% by weight of the pigment (Z) and/or the thickener (W), preferably [2] 0.5 to 70% by weight of the hollow polymer particle (X2), 1 to 15% by weight of the binder (Y), and 0.5 to 70% by weight of the pigment (Z) and/or the thickener (W), and more preferably [3] 30 to 70% by weight of the hollow polymer particle (X2), 1 to 15% by weight of the binder (Y), and 20 to 60% by weight of the pigment (Z) and/or the thickener (W) based on 100% by weight of the total of the components (X2), (Y), (Z) and (W) in terms of solid content.

In this case, the contents of the pigment (Z) and the thickener (W) are 0 to 99% by weight and 0 to 3% by weight respectively, when the contents of the hollow polymer particle (X2) and the binder (Y) are 0.5 to 99.5% by weight in both based on 100% by weight of the total of the components (X2), (Y), (Z) and (W). In addition, the contents of the pigment (Z) and the thickener (W) are 0.5 to 70% by weight and 0.05 to 5% by weight respectively, when the contents of the hollow polymer particle (X2) and the binder (Y) are 0.5 to 70% by weight and 1 to 15% by weight, respectively. Further, the contents of the pigment (Z) and the thickener (W) are 20 to 60% by weight and 0.05 to 5% by weight respectively, when the contents of the hollow polymer particle (X2) and the binder (Y) are 30 to 70% by weight and 1 to 15% by weight, respectively.

Various additives such as a dispersing agent, an antifoaming agent, a waterproof agent, a lubricant, a humectant, a printability improver, a fluorescent bleaching agent, a coloring pigment and a dye in the composition of the present invention.

Performances of coated paper produced using the composition of the second aspect of the present invention under conditions described in Examples can be shown as follows: (1) gloss; 70 to 85, printing gloss; 79 to 96, opacity; 88 to 97, and whiteness; 80 to 87, preferably (2) gloss; 74 to 85, printing gloss; 85 to 96, opacity; 90 to 97, and whiteness; 80 to 87, and more preferably (3) white paper; 81 to 85, printing gloss; 90 to 96, opacity; 91 to 97, and whiteness; 82 to 87.

In the case of using a composition whose contents of the hollow polymer particle (X2), the binder (Y), the pigment (Z) and the thickener (W) are 0.5 to 99.5% by weight, 0.5 to 99.5% by weight, 0 to 99% by weight and 0 to 3% by weight, respectively based on 100% by weight of the total of the components (X1), (Y), (Z) and (W), performances of the coated paper produced can be shown as follows: gloss; 70 to 85, printing gloss; 79 to 96, opacity; 88 to 97, and whiteness; 80 to 87.

In the case of using a composition whose contents of the hollow polymer particle (X2), the binder (Y), the pigment (Z) and the thickener (W) are 0.5 to 70% by weight, 1 to 15% by weight, 0.5 to 70% by weight and 0.05 to 5% by weight, respectively based on 100% by weight of the total of the components (X2), (Y), (Z) and (W), performances of the coated paper produced can be shown as follows: gloss; 74 to 85, printing gloss; 85 to 96, opacity; 90 to 97, and whiteness; 80 to 87.

In the case of using a composition whose contents of the hollow polymer particle (X2), the binder (Y), the pigment (Z) and the thickener (W) are 30 to 70% by weight, 1 to 15% by weight, 20 to 60% by weight and 0.05 to 5% by weight, respectively based on 100% by weight of the total of the components (X2), (Y), (Z) and (W), performances of the coated paper produced can be shown as follows: gloss; 81 to 85, printing gloss; 90 to 96, opacity; 91 to 97, and whiteness; 82 to 87.

The paper coating composition described above can be used as a coating composition except for paper.

3. Coated Paper and a Process for Producing the Coated Paper

The coated paper of the present invention is comprising a base paper and a coating which is formed on a single surface or both surfaces of the base paper and has a hollow polymer particle and a binder, wherein a volume percentage of the hollow polymer particle is 20 to 99%, preferably 50 to 99%, more preferably 51 to 99%, still more preferably 56 to 99%, still more and more 60 to 99%, particularly preferably 63 to 98%, particularly more preferably 65 to 98%, particularly still more preferably 68 to 98% and most preferably 70 to 98%, and an average particle size is 200 to 8,000 nm, preferably 300 to 5,000 nm, more preferably 500 to 3,000 nm, and still more preferably 700 to 2,000 nm.

The hollow polymer particle according to the present invention can be applied to the hollow polymer particle (X) in the above-mentioned item 1. as it is.

The above-mentioned coating can be comprised a pigment, a thickener and the like. The pigment and the thickener can be applied to the pigment (Z) and the thickener (W) respectively in the above-mentioned item 2. as it is.

The binder is a material for bonding the hollow polymer particle, the pigment and the like to each other, and further has a function of bonding the hollow polymer particle and the particle of the pigment to sites where they contact the surface of the paper. The binder is composed as a bonding layer in the coated paper. The binder can be applied to the binder (Y) in the above-mentioned item 2. as it is. The coating can further comprise a dispersing agent, an antifoaming agent, a water resisting agent, a lubricant, a humectant, a printability improver, a fluorescent bleaching agent, a coloring pigment and a dye. These components can be the same as the explanation above as it is.

The coated paper of the present invention can be produced by coating the coating composition described in the above-mentioned item 2. to a base paper.

The coating amount of the coating composition is 0.3 to 30 g/m², preferably 0.5 to 20 g/m2 , and more preferably 1 to 15 g/m² after drying. If the coating amount is less than 0.3 g/m², paper is not sufficiently coated so that opacity, gloss, whiteness and the like thereof deteriorate. If the coating amount is more than 30 g/m², the bulk of the coating layer becomes too large so that the surface strength reduces.

Examples of coating method include contact coating methods using a blade coater such as a short duel coater, a balliduel coater and a rod blade coater; a roll coater such as a gate roll coater, an in-line size press and a metered size press; and non-contact coating methods using an air knife coater, a curtain coater, a spray coater and the like.

Among these methods, the non-contact coating methods using a curtain coater, a spray coater and the like are particularly preferred from the viewpoint of opacity, whiteness, gloss and printing gloss.

In a post-treatment step, it is preferred to conduct calendar treatment using a super calendar, a gloss calendar, a soft nip calendar, a luster press and the like. This makes it possible to obtain coated paper superior in gloss.

### DESCRIPTION OF THE PREFERRED EMBODIMENTS

The present invention is further described in the following examples. However, the present invention is not limited by the Examples.

In the following description, the word “part(s)” and the symbol “%” represent “part(s) by weight” and “% by weight”, respectively, unless otherwise specified.

### EXAMPLE 1

(1) Preparation of an Aqueous Dispersed Product Containing a Seed Particle

Into a reaction vessel having a volume of 2 liters were beforehand charged 109.5 parts of water as a medium, 0.2 part of sodium dodecylbenzenesulfonate (Trade name; “F65”, manufactured by Kao Corp.) as an emulsifier, and 0.5 part of sodium persulfate as a polymerization initiator.

Separately, 90 parts of methyl methacrylate, 10 parts of methacrylic acid, 0.5 part of octyl thioglycolate as a molecular weight adjustor, an emulsifier (Trade name; “F65”, manufactured by Kao Corp.), and 40 parts of water were mixed and stirred to prepare an aqueous dispersed product (i) containing a monomer mixture.

Into the above-mentioned reaction vessel was charged 20% of the aqueous dispersed product (i) containing the monomer mixture. While the liquid in the reaction vessel was stirred, the temperature was raised to 75° C. to polymerize for 1 hour. Thereafter, while was keeping the temperature 75° C., the rest of the aqueous dispersed product (i) was continuously added to the reaction vessel over 2 hours. Furthermore, a resultant was ripened for 2 hours to yield an aqueous dispersed product (ii) containing a seed particle having a solid content of 40%, a particle size of 200 nm and a weight-average molecular weight of 70,000.

(2) Production of an Aqueous Dispersed Product Containing Polymer Particle (A)

Preparation example of an aqueous dispersed product containing polymer particle (A) will be described as the following Production Examples 1 to 5.

### Production Example 1

Into a reaction vessel having a volume of 2 liters were beforehand charged 186 parts of water as a medium, and thereto were charged 10 parts of the above-mentioned seed particle in terms of solid content (25 parts as the aqueous dispersed product (ii) containing the seed particle), and 0.5 part of sodium persulfate as a polymerization initiator.

Separately, 69.5 parts of methyl methacrylate, 30 parts of methacrylic acid, 0.5 part of divinylbenzene (purity: 55%), 0.1 part of an emulsifier (Trade name; “F65”, manufactured by Kao Corp.), and 40 parts of water were mixed and stirred to prepare an aqueous dispersed product (iii) containing a monomer mixture.

Next, while the liquid in the reaction vessel was stirred, the temperature was raised to 80° C. and kept. The aqueous dispersed product (iii) containing the monomer mixture was continuously added to the reaction vessel over 3 hours. Thereafter, a resultant was ripened for 2 hours to yield an aqueous dispersed product containing a polymer particle A-1 having a particle size of 410 nm and having a solid content of 31%.

### Production Examples 2 to 5

Polymerization was performed in the same manner as in the case of the polymer particle A-1 except that the amount to be charged and the monomer components were changed as shown in Table 1, so as to yield aqueous dispersed product containing polymer particles A-2 to A-5.

TABLE 1

| | Production example | | | | |
|---|---|---|---|---|---|
| | 1-1 | 1-2 | 1-3 | 1-4 | 1-5 |
| Polymer particle A | A-1 | A-2 | A-3 | A-4 | A-5 |
| Seed particle | 10 | 3 | 17 | 10 | 10 |
| Monomer (a-1) | 30 | 30 | 30 | 10 | 50 |
| Methacrylic acid | | | | | |
| Monomer (a-2) | | | | | |
| Methylmethacrylate | 69.5 | 69.5 | 69.5 | 59.8 | 18.0 |
| Acrylonitrile | — | — | — | 10 | — |
| Styrene | — | — | — | 20 | 30 |
| Divinylbenzene | 0.5 | 0.5 | 0.5 | 0.2 | 2.0 |
| Solid content (%) | 31.0 | 30.7 | 31.2 | 31.1 | 29.8 |
| Particle diameter (nm) | 410 | 570 | 330 | 400 | 380 |
| Polymerization stability (visual) | ◯ | ◯ | ◯ | ◯ | ◯˜Δ |

In Table 1, polymerization stability is evaluated as ◯, Δ and × according to the state that aggregates adhere to the reaction vessel and stirring fans.

◯; the amount of the aggregates was little,

Δ; the amount of the aggregates was somewhat large, and

×; the amount of the aggregates was large.

(3) Production of a Hollow Polymer Particle (X) and Evaluation

Production example of hollow polymer (X) will be described as the following Examples 1-1 to 1-11 and Comparative example 1-1 to 1-5.

### Example 1-1

Into a reaction vessel having a volume of 2 liters were beforehand charged 240 parts of water as a medium, and thereto were charged 15 parts of the aqueous dispersed product containing the polymer particle A-1 prepared as described above, in terms of solid content (48.4 parts as the aqueous dispersed product), 20 parts of styrene, and 0.4 part of sodium persulfate as a polymerization initiator.

Separately, 69.5 parts of styrene, 0.1 part of an emulsifier (Trade name; “F65”, manufactured by Kao Corp.), and 40 parts of water were mixed and stirred to prepare an aqueous dispersed product (iv) containing a monomer.

Next, while the liquid in the reaction vessel was stirred, the temperature was raised to 80° C. and kept to polymerize styrene for 30 minutes. In this way, a styrene composited polymer particle was produced. Subsequently, while the liquid in the reaction vessel was stirred, the above-mentioned aqueous dispersed product (iv) containing the monomer added continuously into the reaction vessel over 4 hours at 80° C. When 2 hours after the start of the adding of the aqueous dispersed product (iv) containing the monomer, 0.5 part of acrylic acid was collectively charged into the reaction vessel to be copolymerized with styrene. Furthermore, immediately after all of the aqueous dispersed product (iv) containing the monomer was charged into the reaction vessel, 5 parts of divinylbenzene and 5 parts of styrene were collectively charged into the reaction vessel to yield a core/shell type polymer particles B1-1 wherein styrene, acrylic acid and divinylbenzene were polymerized and covered the surface of the polymer particle A-1.

After about 15 minutes from the end of the charging of all the monomers, 5 parts of 25% ammonium hydroxide were collectively charged into the reaction system while stirring. The temperature of the system was then raised to 90° C., and the system was stirred for 2 hours and ripened. The weight ratio of the unreacted monomers (b) to the whole of the monomers (b) immediately before the charging of 25% ammonium hydroxide was 7%.

Thereafter, thereto were charged 0.3 part of t-butyl hydroperoxide and 0.1 part of formaldehyde resin, and then mixture was stirred for 1 hour to yield an aqueous dispersed product containing a spherical hollow polymer particle X1-1 having a solid content of 26.5%, a particle size of 1,050 nm, an inner diameter of 860 nm and a single hollow with a volume percentage of hollowness of 55%.

### Examples 1-2 to 1-11 and Comparative Examples 1-1 to 1-5

Hollow polymer particles X1-2 to X1-11 were prepared in the same manner as in Example 1 except that the kind of the polymer particle (A), the amount thereof, the monomers (b), the content of unreacted monomers (b) when pH was raised, and heating temperature after pH was raised were changed as shown in Table 2. Hollow polymer particles X1-12 to X1-16, which were examples out of the scope of the hollow polymer particles (X) of the present invention, were prepared in substantially the same way as in Example 1 according to Table 3.

Because of high viscosity, pH-raising and heating are performed after solid content was diluted to 18% in (B1-3) and (B1-11).

TABLE 21

| | Example | | | | | |
|---|---|---|---|---|---|---|
| | 1-1 | 1-2 | 1-3 | 1-4 | 1-5 | 1-6 |
| Polymer particle B | B1-1 | B1-2 | B1-3 | B1-4 | B1-5 | B1-6 |
| Used polymer particle A | A-1 | A-1 | A-1 | A-1 | A-1 | A-1 |
| Amount of polymer particle A | 15 | 5 | 50 | 15 | 15 | 15 |
| Monomer (b-1) | | | | | | |
| Acrylic acid | 0.5 | 0.5 | 0.5 | 1 | 0.5 | — |
| Itaconic acid | — | — | — | — | 0.5 | — |
| Monomer (b-2) | | | | | | |
| [Monomer charged collectively at first] | | | | | | |
| Methylmethacrylate | — | — | — | 10 | 10 | — |
| Styrene | 20 | 10 | 20 | 10 | — | 20 |
| [Continuously-added water-dispersion monomer] | | | | | | |
| Styrene | 69.5 | 89 | 79.5 | 77 | 72 | 70 |
| Butylacrylate | — | — | — | — | 15 | — |
| [Monomer charged collectively at final] | | | | | | |
| Styrene | 5 | — | — | 1 | — | — |
| Divinylbenzene | 5 | — | — | 1 | 2 | 10 |
| Ethyleneglycoldimethacrylate | — | 5 | — | — | — | — |
| Particle diameter (nm) | 790 | 1110 | 570 | 790 | 760 | 750 |
| Tg of polymer constituting shell layer (° C.) | 115 | 106 | 106 | 107 | 75 | 123 |
| Polymerization stability (visual) | ◯ | ◯ | ◯ | ◯ | ◯ | ◯ |
| Hollow polymer particle X | X1-1 | X1-2 | X1-3 | X1-4 | X1-5 | X1-6 |
| Polymer particle B | B1-1 | B1-2 | B1-3 | B1-4 | B1-5 | B1-6 |
| Polymerization temperature of (b) when pH was | 90 | 85 | 80* | 85 | 70 | 80 |
| raised up (° C.) | | | | | | |
| Unreacted monomer content in (b) when pH was | 7 | 15 | 3 | 7 | 5 | 10 |
| raised up (% by weight) | | | | | | |
| Particle diameter after treating (nm) | 1050 | 1220 | 890 | 1000 | 1080 | 940 |
| Inner hole diameter after treating (nm) | 860 | 800 | 786 | 810 | 930 | 750 |
| Volume percentage of hollowness (%) | 55 | 28 | 69 | 53 | 64 | 51 |
| Morphology with a microscope | | | | | | |

| | |
|---|---|
| Shape | Spherical |
| Inner hole | Single hole |

*Because of high viscosity, pH-raising and heating are performed after solid content was diluted to 18%.

TABLE 2-2

| | Example | | | | |
|---|---|---|---|---|---|
| | 1-7 | 1-8 | 1-9 | 1-10 | 1-11 |
| Polymer particle B | B1-7 | B1-8 | B1-9 | B1-10 | B1-11 |
| Used polymer particle A | A-1 | A-2 | A-3 | A-4 | A-5 |
| Amount of polymer particle A | 15 | 15 | 15 | 15 | 15 |
| Monomer (b-1) | | | | | |
| Acrylic acid | 10 | — | 0.5 | 0.5 | 0.5 |
| Itaconic acid | — | 0.5 | — | — | — |
| Monomer (b-2) | | | | | |
| [Monomer charged collectively at first] | | | | | |
| Methylmethacrylate | — | — | — | — | — |
| Styrene | 20 | 20 | 20 | 20 | 20 |
| [Continuously-added water-dispersion monomer] | | | | | |
| Styrene | 68 | 69.5 | 66.5 | 59.5 | 68.5 |
| Butylacrylate | — | — | 10 | — | 10 |
| [Monomer charged collectively at final] | | | | | |
| Styrene | — | 5 | — | — | — |
| Divinylbenzene | — | 5 | 3 | 20 | 1 |
| Ethyleneglycoldimethacrylate | | — | — | — | — |
| Particle diameter (nm) | 760 | 1150 | 660 | 790 | 760 |
| Tg of polymer constituting shell layer (° C.) | 108 | 114 | 88 | 120 | 85 |
| Polymerization stability (visual) | ◯ | ◯ | ◯ | ◯ | ◯˜Δ |
| Hollow polymer particle X | X1-7 | X1-8 | X1-9 | X1-10 | X1-11 |
| Polymer particle B | B1-7 | B1-8 | B1-9 | B1-10 | B1-11 |
| Polymerization temperature of (b) when pH was | 83 | 85 | 85 | 85 | 75* |
| raised up (° C.) | | | | | |
| Unreacted monomer content in (b) when pH was | 20 | 10 | 7 | 7 | 5 |
| raised up (% by weight) | | | | | |
| Particle diameter after treating (nm) | 1010 | 1490 | 870 | 900 | 1070 |
| Inner hole diameter after treating (nm) | 830 | 1230 | 690 | 620 | 920 |
| Volume percentage of hollowness (%) | 55 | 56 | 50 | 33 | 64 |
| Morphology with a microscope | | | | | |

| | |
|---|---|
| Shape | Spherical |
| Inner hole | Single hole |

*Because of high viscosity, pH-raising and heating are performed after solid content was diluted to 18%.

TABLE 3

| | Comparative example | | | | |
|---|---|---|---|---|---|
| | 1-1 | 1-2 | 1-3 | 1-4 | 1-5 |
| Polymer particle B | B1-12 | B1-13 | B1-14 | B1-15 | B1-16 |
| Used polymer particle A | A-1 | A-1 | A-1 | A-1 | A-1 |
| Amount of polymer particle A | 15 | 15 | 15 | 3 | 15 |
| Monomer (b-1) | | | | | |
| Acrylic acid | 0.5 | 0.5 | 0.5 | 0.5 | 0.5 |
| Itaconic acid | — | — | — | — | — |
| Monomer (b-2) | | | | | |
| [Monomer charged collectively at first] | | | | | |
| Methylmethacrylate | — | — | — | — | — |
| Styrene | 20 | 20 | 1 | 20 | 20 |
| [Continuously-added water-dispersion monomer] | | | | | |
| Styrene | 69.5 | 69.5 | 88.5 | 69.5 | 49.5 |
| Butylacrylate | — | — | — | — | 20 |
| [Monomer charged collectively at final] | | | | | |
| Styrene | 5 | 5 | 5 | 5 | 5 |
| Divinylbenzene | 5 | 5 | 5 | 5 | 5 |
| Ethyleneglycoldimethacrylate | — | — | — | — | — |
| Particle diameter (nm) | 790 | 790 | 780 | 1320 | 800 |
| Tg of polymer constituting shell layer (° C.) | 115 | 115 | 115 | 115 | 75 |
| Polymerization stability (visual) | ◯ | ◯ | ◯ | ◯ | ◯ |
| Hollow polymer particle X | X1-12 | X1-13 | X1-14 | X1-15 | X1-16 |
| Polymer particle B | B1-12 | B1-13 | B1-14 | B1-15 | B1-16 |
| Temperature of (b) when pH was raised up (° C.) | 90 | 80 | 90 | 90 | 80 |
| Unreacted monomer content when pH was raised | 0 | 52 | 7 | 7 | 7 |
| up (% by weight) | | | | | |
| Particle diameter after treating (nm) | 850 | 850 | 1000 | 1340 | 860 |
| Inner hole diameter after treating (nm) | 264 | — | — | — | — |
| Volume percentage of hollowness (%) | 3 | — | — | — | — |
| Morphology with a microscope | | | | | |
| Shape | Spherical | Rupture | bowl-form | Spherical | Rupture |
| Inner hole | Single hole | none | Single hole | none | none |

In Tables 2 and 3, polymerization stability is evaluated as ◯, Δ and × according to the state that aggregates adhere to the reaction vessel and stirring fans.

◯; the amount of the aggregates was little,

Δ; the amount of the aggregates was somewhat large, and

×; the amount of the aggregates was large.

The evaluation methods of the hollow polymer particle (X) are as follows.

\mathring{1} Average Particle Size

The average particle size was an average value of results obtained by observing 100 particles, which were randomly selected, at a magnification of 5,000 with an electron microscopy (Type; “JSM-6360LA”, manufactured by NIPPON DENSHI Co., Ltd.).

\mathring{2} Average Inner Hole Diameter

The average inner hole diameter was an average value of results obtained by observing 100 particles, which were randomly selected, at a magnification of 5,000 with an electron microscopy (Type; “JSM-6360LA”, manufactured by NIPPON DENSHI Co., Ltd.).

\mathring{3} Volume Percentage of Hollowness

Using the average particle size and the average inner hole diameter, particle volume and inner hole volume were calculated. And the volume percentage of hollowness was obtained by the following equation using the calculated particle volume and inner hole volume.

(inner hole volume/particle volume)×100(%)

\mathring{4} External Form, and Form of Hollow Hole

The external form and the form of the inner hole were observed at a magnification of 5,000 with an electron microscopy (Type; “JSM-6360LA”, manufactured by NIPPON DENSHI Co., Ltd.).

(4) Effects of Example 1-1 to 1-11 (Hollow Polymer Particles)

Comparative example 1-1 was an example wherein the weight ratio of the unreacted monomers (b) to the whole of the monomers (b) was less than 1% when pH was raised up and 2 hours after the addition of all of the monomers (b), the pH was raised up. After the polymerization conversion of the monomers (b) was over 99%, a particle having a sufficient volume percentage of hollowness was not obtained.

Comparative example 1-2 was an example wherein the weight ratio of the unreacted monomers (b) to the whole of the monomers (b) was over 50% when pH was raised up and immediately after the addition of all of the monomers (b), the pH was raised up. The temperature of the polymerization was set to 75° C. In the case in which pH was raised up when the polymerization conversion of the monomers (b) was less than 50%, a shell layer was broken by swelling pressure of core portions so that a particle ruptured. As a result, no hollow polymer particle was yielded.

Comparative example 1-3 was an example wherein the ratio of the monomer (b-2) collectively charged at first to the polymer particle (A) was set to 1/10 or less and core was one-sided in the polymer particle (B). When pH was raised up in this state, thickness of the shell of the hollow polymer particle did not become uniform. Thus, after drying, the shell caved in so that bowl-form particle was yielded.

Comparative example 1-4 was an example wherein the amount of the polymer particle (A) was 5 parts or less based on 100 parts of the monomers (b). The amount of swelled core was too small. Thus, a sufficient volume percentage of hollowness was not obtained.

Comparative example 1-5 was an example wherein the temperature of the dispersed product when the polymer particle (B) was neutralized and swelled was higher than the glass transition temperature (Tg) of the polymer constituting the shell of the hollow polymer particle. The shell layer was broken by swelling pressure of the core portion so that a particle ruptured. As a result, no hollow polymer particle was yielded.

On the other hand, the hollow polymer particles X1-1 to X1-11 in Examples 1-1 to 1-11 were spherical hollow particles each of which had a sufficient volume percentage of hollowness and a single hollow. Polymerization stability and yield at the time of the respective polymerizations were good.

(5) Application to a Paper Coating Composition

### Example 1-12 to 1-22 and Comparative example 1-6 to 1-12

The hollow polymer particles X1-1 to X1-11 obtained in Examples 1-1 to 1-11 were used to prepare paper coating compositions by the formulations (I) described below. The particles X1-1 obtained in Example 1-1, X1-12 to X1-16 obtained in Comparative Examples 1-1 to 1-5, and a solid plastic pigment (Trade name; “JSR0640”, manufactured by JSR Corp.) were used to prepare Comparative examples 1-6 to 1-12. In order to evaluate the paper coating compositions, plural pieces of coated paper were made under coating conditions (II) described below, and resultant pieces were evaluated by the method (III).

(I) Formulation of Paper Coating Composition

0.05% by weight of a dispersing agent (Trade name; “ARON T-40”, manufactured by Toagosei Co., Ltd.), and 0.2% by weight of sodium hydroxide were dissolved in water. While stirring a resultant solution with a Kores dispersing machine, inorganic pigments shown in Tables 4 and 5 were added to the solution.

After the solution was stirred for 30 minutes, to the solution were added a prescribed amount of hollow polymer particle X1-1 to X1-16, and JSR0640, 10% by weight (in terms of solid content) of a copolymer latex (Trade name; “JSR0619”, manufactured by JSR Corp.) as a binder, and 3% by weight of starch (Trade name; “MS-4600”, manufactured by Nippon Shokuhin Co., Ltd.). Water was added thereto in such a manner that the content by weight of all solids would be 62% by weight. In this way, a paper coating composition was formulated.

In the case of Comparative example 1-12, the amount of the hollow polymer particle X1-1 was set to 0.08% by weight (solid content).

(II) Production of Coated Paper

Commercially available fine paper (weighting capacity; 72 g/m²) as a base paper was coated with the above-mentioned paper coating composition by means of a rod bar in such a manner that the coating amount thereof after drying would be 15 g/m² (single face), and then a resultant was dried at 150° C. in a gear oven for 5 seconds. A resultant single face coated paper was passed two times through “Labo Super Calendar” (manufactured by Yuri Roll Corp.) having a roll surface temperature of 40° C. at a line pressure of 10N/m to yield a glossy coated paper.

(III) Evaluating Method of the Coated Paper

The coated paper produced as described was evaluated according to the following method. The results are shown in Tables 4 and 5.

\mathring{1} Dry Picking Strength

An RI type printer was used to perform a over-printing several times using a tack No. 9 ink. The picking state on the printed face was evaluated by visual observation. (Evaluation: a score out of 5. As the score is larger, the strength is better.)

\mathring{2} Wet Picking Strength

An RI type printer was used. Water was supplied on a test piece by means of a Morton roll, and subsequently printing was performed once. The picking state on the printed face was evaluated by visual observation. (Evaluation: a score out of 5. As the score is larger, the strength is better.)

\mathring{3} Gloss

A Murayama type gloss meter was used to measure the gloss of the coated paper which has not yet been printed at an incident angle of 75 degrees and a reflection angle of 75 degrees. As a resultant value is larger, the gloss is better.

\mathring{4} Whiteness

A Hunter colorimetry and a whiteness meter were used to measure the whiteness of the coated paper, using a blue filter. As a resultant value is larger, the whiteness is better.

\mathring{5} Opacity

A Hunter colorimetry and a whiteness meter were used to measure the opacity of the coated paper, using a green filter. As a resultant value is larger, the opacity is better.

\mathring{5} Heat Resistance

A sample was passed once through a Labo Gloss Calendar (manufactured by Yuri Roll Corp.) at a surface temperature of 180° C. and a line pressure of 3 N/m. Thereafter, the opacity was measured in the same way as in the item \mathring{5}. A difference between the thus-measured opacity and the opacity measured in the item \mathring{5} was used as heat resistance data. As a resultant value is smaller, the heat resistance is better. \mathring{7} Oken type air-infiltration smoothness

An Oken type air-infiltration smoothness meter was used to measure the smoothness of a sample. As a resultant value is larger, the smoothness is larger.

TABLE 41

| | Example | | | | | |
|---|---|---|---|---|---|---|
| | 1-12 | | 1-13 | 1-14 | 1-15 | 1-16 |
| Hollow polymer | | | | | | |
| particle X | | | | | | |
| Component | X1-1 | | X1-2 | X1-3 | X1-4 | X1-5 |
| Amount (parts) | 10 | (8.8) | 10 | 10 | 10 | 10 |
| Inorganic-based | | | | | | |
| pigment Z (parts) | | | | | | |
| First class clay*¹ | 30 | | 30 | 30 | 30 | 30 |
| Second class clay*² | 30 | | 30 | 30 | 30 | 30 |
| Calcium carbonate*³ | 30 | | 30 | 30 | 30 | 30 |
| Total | 90 | (79.6) | 90 | 90 | 90 | 90 |
| Total of X1 and Z (parts) | 100 | | 100 | 100 | 100 | 100 |
| Binder Y (parts) | | | | | | |
| JSR0619 | 10 | | 10 | 10 | 10 | 10 |
| Starch MS4600 | 3 | | 3 | 3 | 3 | 3 |
| Total | 13 | (11.5) | 13 | 13 | 13 | 13 |
| Total of X, Z and Y (parts) | 113 | (100.0) | 113 | 113 | 113 | 113 |
| Physical properties | | | | | | |
| of coated paper | | | | | | |

| | | | | | |
|---|---|---|---|---|---|
| Dry picking | 4.2 | 4.3 | 4.2 | 4.5 | 4.7 |
| Wet picking | 4.3 | 4.4 | 4.3 | 4.5 | 4.4 |
| Gloss | 78.2 | 76.1 | 80.1 | 78.5 | 79.3 |
| Opacity | 92.4 | 90.3 | 94.3 | 92.1 | 93.8 |
| Heat resistance | 0.5 | 1.2 | 4.4 | 1.2 | 1.4 |
| (opacity fall value) | | | | | |
| Whiteness | 84.3 | 82.3 | 85.6 | 84.5 | 85.0 |
| Oken-type smoothness | 3420 | 3320 | 3690 | 3570 | 3600 |

*¹Trade name; “UW90”, manufactured by EMC Co., Ltd.
*²Trade name; “HS”, manufactured by Huer Co., Ltd.
*³Trade name; “Calpital 90”, manufactured by ECC Co., Ltd.

TABLE 4-2

| | Example | | | | | |
|---|---|---|---|---|---|---|
| | 1-17 | 1-18 | 1-19 | 1-20 | 1-21 | 1-22 |
| Hollow polymer | | | | | | |
| particle X1 | | | | | | |
| Component | X1-6 | X1-7 | X1-8 | X1-9 | X1-10 | X1-11 |
| Amount (parts) | 10 | 10 | 10 | 10 | 10 | 10 |
| Inorganic-based | | | | | | |
| pigment Z (parts) | | | | | | |
| First class clay*¹ | 30 | 30 | 30 | 30 | 30 | 30 |
| Second class clay*² | 30 | 30 | 30 | 30 | 30 | 30 |
| Calcium carbonate*³ | 30 | 30 | 30 | 30 | 30 | 30 |
| Total | 90 | 90 | 90 | 90 | 90 | 90 |
| Total of X1 and Z (parts) | 100 | 100 | 100 | 100 | 100 | 100 |
| Binder Y (parts) | | | | | | |
| JSR0619 | 10 | 10 | 10 | 10 | 10 | 10 |
| Starch MS4600 | 3 | 3 | 3 | 3 | 3 | 3 |
| Total | 13 | 13 | 13 | 13 | 13 | 13 |
| Total of X1, Z and Y (parts) | 113 | 113 | 113 | 113 | 113 | 113 |
| Physical properties | | | | | | |
| of coated paper | | | | | | |
| Dry picking | 4.3 | 4.8 | 4.2 | 4.1 | 4.3 | 4.6 |
| Wet picking | 4.6 | 4.3 | 4.5 | 4.3 | 4.6 | 4.2 |
| Gloss | 78.3 | 78.4 | 78.9 | 77.1 | 76.4 | 79.7 |
| Opacity | 92.0 | 92.3 | 92.9 | 91.9 | 90.5 | 93.7 |
| Heat resistance | 0.8 | 1.4 | 0.4 | 1.3 | 0.2 | 1.5 |
| (opacity fall value) | | | | | | |
| Whiteness | 83.2 | 84.4 | 84.6 | 84.2 | 82.1 | 85.2 |
| Oken-type smoothness | 3430 | 3420 | 3450 | 3390 | 3310 | 3590 |

*¹Trade name; “UW-90”, manufactured by EMC Co., Ltd.
*²Trade name; “HS”, manufactured by Huer Co., Ltd.
*³Trade name; “Calpital 90”, manufactured by ECC Co., Ltd.

TABLE 5

| | Comparative example | | | | | | | | |
|---|---|---|---|---|---|---|---|---|---|
| | 1-6 | | 1-7 | 1-8 | 1-9 | 1-10 | 1-11 | 1-12 | |
| Particle | | | | | | | | | |
| Component | X1-12 | | X1-13 | X1-14 | X1-15 | X1-16 | JSR0640 | X1-1 | |
| Amount (parts) | 10 | (8.8) | 10 | 10 | 10 | 10 | 10 | 0.08 | (0.08) |
| Inorganic-based | | | | | | | | | |
| pigment Z (parts) | | | | | | | | | |
| First class clay*¹ | 30 | | 30 | 30 | 30 | 30 | 30 | 30 | |
| Second class clay*² | 30 | | 30 | 30 | 30 | 30 | 30 | 30 | |
| Calcium carbonate*³ | 30 | | 30 | 30 | 30 | 30 | 30 | 30 | |
| Total | 90 | (79.6) | 90 | 90 | 90 | 90 | 90 | 90 | (87.31) |
| Total of Particle and Z (parts) | 100 | | 100 | 100 | 100 | 100 | 100 | 90.08 | |
| Binder Y (parts) | | | | | | | | | |
| JSR0619 | 10 | | 10 | 10 | 10 | 10 | 10 | 10 | |
| Starch MS4600 | 3 | | 3 | 3 | 3 | 3 | 3 | 3 | |
| Total | 13 | (11.5) | 13 | 13 | 13 | 13 | 13 | 13 | (12.61) |
| Total of Particle, Z and Y (parts) | 113.0 | (100.0) | 113.0 | 113.0 | 113.0 | 113.0 | 113.0 | 103.1 | (100.0) |
| Physical properties | | | | | | | | | |
| of coated paper | | | | | | | | | |

| | | | | | | | |
|---|---|---|---|---|---|---|---|
| Dry picking | 3.7 | 3.9 | 3.6 | 3.5 | 3.9 | 4.6 | 4.3 |
| Wet picking | 3.2 | 3.8 | 3.4 | 3.1 | 3.4 | 4.7 | 4.2 |
| Gloss | 69.1 | 67.2 | 69.9 | 68.2 | 67.7 | 65.3 | 60.1 |
| Opacity | 89.1 | 88.4 | 89.3 | 88.9 | 88.5 | 86.4 | 86.5 |
| Heat resistance | 3.1 | 3.2 | 2.6 | 3.1 | 3.9 | 5.4 | 0.3 |
| (opacity fall value) | | | | | | | |
| Whiteness | 82.2 | 81.1 | 82.8 | 82.0 | 82.5 | 80.1 | 78.8 |
| Oken-type smoothness | 2990 | 2890 | 2990 | 2910 | 2880 | 2740 | 2560 |

*¹Trade name; “UW-90”, manufactured by EMC Co., Ltd.
*²Trade name; “HS”, manufactured by Huer Co., Ltd.
*³Trade name; “Calpital 90”, manufactured by ECC Co., Ltd.

(6) Effects of Examples 1-12 to 1-22 (Coated Paper)

Comparative examples 1-6 to 1-12 were examples wherein hollow polymer particles produced by the process out of the scope of the present invention were used. Their properties were as follows: dry picking strength; 3.7 to 3.9, wet picking strength; 3.1 to 3.8, gloss; 67.2 to 69.9, opacity; 88.4 to 89.3, heat resistance; 2.6 to 3.9, whiteness; 81.1 to 82.8, and Oken type smoothness; 2,880 to 2,990. Thus, properties for coated paper were poor.

Comparative example 1-11 was an example wherein a known polymer particle which was not hollow was used as a polymer particle. In this case, the above-mentioned properties were as follows: dry picking strength; 4.6, wet picking strength; 4.7, and heat resistance; 5.4, which were relatively good, but gloss; 65.3, opacity; 86.4, whiteness; 80.1, and Oken type smoothness; 2,740. Thus, the balance of properties for coated paper was not good.

Comparative example 1-12 was an example wherein the hollow polymer particle X1-1, which were produced by an example of the production process of the present invention, were used but the content of the hollow polymer particle was less than 0.1% (i.e., 0.08%). In this case, the above-mentioned properties were as follows: dry picking strength; 4.3, and wet picking strength; 4.2, which were relatively good, but gloss; 60.1, opacity; 86.5, heat resistance; 0.3, whiteness; 78.8, and Oken type smoothness; 2,560. Thus, the balance of properties for coated paper was not good.

On the other hand, Examples 1-12 to 1-22 were examples wherein there were used coating compositions wherein the hollow polymer particles X1-1 to X1-11, each of which was produced by an example of the production process of the present invention, were contained at a prescribed amount. In this case, the above-mentioned properties were as follows: dry picking strength; 4.2 to 4.8, wet picking strength; 4.2 to 4.6, gloss; 76.4 to 80.1, opacity; 90.3 to 94.3, heat resistance; 0.2 to 4.4, whiteness; 82.3 to 85.6, and Oken type smoothness; 3,310 to 3,690. Thus, the balance of properties for coated paper was superior.

### EXAMPLE 2

(1) Preparation of an Aqueous Dispersed Product Containing a Seed Particle

Into a reaction vessel having a volume of 2 liters were beforehand charged 109.5 parts of water as a medium, 0.2 part of sodium dodecylbenzenesulfonate (Trade name; “F65”, manufactured by Kao Corp.) as an emulsifier, and 0.5 part of sodium persulfate as a polymerization initiator.

Separately, 90 parts of methyl methacrylate, 10 parts of methacrylic acid, 0.5 part of octyl thioglycolate as a molecular weight adjustor, an emulsifier (Trade name; “F65”, manufactured by Kao Corp.), and 40 parts of water were mixed and stirred to prepare an aqueous dispersed product (i) containing a monomer mixture.

Into the above-mentioned reaction vessel was charged 20% of the aqueous dispersed product (i) containing the monomer mixture. While the liquid in the reaction vessel was stirred, the temperature was raised to 75° C. to polymerize for 1 hour. Thereafter, while was keeping the temperature 75° C., the rest of the aqueous dispersed product (i) was continuously added to the reaction vessel over 2 hours. Furthermore, a resultant was ripened for 2 hours to yield an aqueous dispersed product (ii) containing a seed particle having a solid content of 40%, a particle size of 200 nm and a weight-average molecular weight of 70,000.

(2) Production of an Aqueous Dispersed Product Containing Polymer Particle (A)

Preparation example of an aqueous dispersed product containing polymer particle (A) will be described as follows.

Into a reaction vessel having a volume of 2 liters were beforehand charged 186 parts of water as a medium, and thereto were charged 10 parts of the above-mentioned seed particle in terms of solid content (25 parts as the aqueous dispersed product (ii) containing the seed particle), and 0.5 part of sodium persulfate as a polymerization initiator.

Separately, 69.5 parts of methyl methacrylate, 30 parts of methacrylic acid, 0.5 part of divinylbenzene (purity: 55%), 0.1 part of an emulsifier (Trade name; “F65”, manufactured by Kao Corp.), and 40 parts of water were mixed and stirred to prepare an aqueous dispersed product (iii) containing a monomer mixture.

Next, while the liquid in the reaction vessel was stirred, the temperature was raised to 80° C. and kept. The aqueous dispersed product (iii) containing the monomer mixture was continuously added to the reaction vessel over 3 hours. Thereafter, a resultant was ripened for 2 hours to yield an aqueous dispersed product containing a polymer particle A-1 having a particle size of 410 nm and having a solid content of 31%.

(3) Production of a Hollow Polymer Particle (X) and Evaluation

A polymer particle (B) was prepared in the same manner as in the above-mentioned Example 1 and a hollow polymer particle (X) was produced by using the polymer particle (B). Preparation examples of the hollow polymer particles of the present invention will be described as the following Examples 2-1 to 2-14.

### Example 2-1

Into a reaction vessel having a volume of 2 liters were beforehand charged 300 parts of water as a medium, and thereto were charged 16 parts of the aqueous dispersed product containing the polymer particle A-1 prepared as described above, in terms of solid content (51.6 parts as the aqueous dispersed product), 10 parts of styrene as the monomer (b-2) to be charged collectively, and 0.4 part of sodium persulfate as a polymerization initiator.

Separately, 69.5 parts of styrene as the monomer (b-2) to be charged continuously, 0.1 part of an emulsifier (Trade name; “F65”, manufactured by Kao Corp.), 0.5 part of acrylic acid as the monomer (b-1) and 40 parts of water were mixed and stirred to prepare an aqueous dispersed product (v) containing a monomer.

Next, while the liquid in the reaction vessel was stirred, the temperature was raised to 80° C. and kept to polymerize styrene for 30 minutes. In this way, a styrene composited polymer particle was produced. Subsequently, while the liquid in the reaction vessel was stirred, the above-mentioned aqueous dispersed product (v) containing the monomer added continuously into the reaction vessel over 4 hours at 80° C. Furthermore, immediately after all of the aqueous dispersed product (v) containing the monomer was charged into the reaction vessel, 20 parts of styrene were collectively charged into the reaction vessel to yield a core/shell type polymer particles B2-1 wherein styrene and acrylic acid were polymerized and covered the surface of the polymer particle A-1. The particle size of the polymer particle B2-1 was 810 nm.

After about 3 minutes from the end of the charging of all the monomers, 2 parts of 25% ammonium hydroxide (8 parts as the solution) were collectively charged into the reaction system while stirring. The system was stirred for 2 hours and ripened. The weight ratio of the unreacted monomers (b) to the whole of the monomers (b) immediately before the charging of 25% ammonium hydroxide was 9%.

Thereafter, thereto were charged 0.3 part of t-butyl hydroperoxide and 0.1 part of formaldehyde resin, and then mixture was stirred for 1 hour to yield an aqueous dispersed product containing a spherical hollow polymer particle X2-1 having a solid content of 23.3%, a particle size of 1,100 nm and an inner diameter of 930 nm.

### Examples 2-2 to 2-14

Polymer particles X2-2 to X1-11 were prepared in the same manner as in Example 1 except that both amounts and kinds in the polymer particle (A-1) and the monomer (b) were changed. In Examples 2-3 and 2-9, hollow polymer particles were produced in the same manner as in Example 2-1 except that the solid contents in the (B2-3) and (B2-9) were diluted to 18% to conduct a heating treatment at the time of adjusting the pH thereof. And the other hollow polymer particles were produced in the same manner as in Example 2-1 except the content of unreacted monomers (b) when pH was adjusted and the heating temperature were changed as shown in Table 6.

TABLE 6-1

| | Example | | | | |
|---|---|---|---|---|---|
| | 2-1 | 2-2 | 2-3 | 2-4 | 2-5 |
| Polymer particle B | B2-1 | B2-2 | B2-3 | B2-4 | B2-5 |
| Used polymer particle A | A-1 | A-1 | A-1 | A-1 | A-1 |
| Amount of polymer particle A | 16 | 10 | 20 | 16 | 16 |
| Monomer (b-1) | | | | | |
| Acrylic acid | 0.5 | 0.5 | 1 | 0.5 | 0.5 |
| Itaconic acid | — | — | — | — | 0.5 |
| Monomer (b-2) | | | | | |
| [Monomer charged collectively at first] | | | | | |
| Methylmethacrylate | — | — | — | — | — |
| Styrene | 10 | 10 | 20 | 10 | 10 |
| [Continuously-added water-dispersion monomer] | | | | | |
| Styrene | 69.5 | 59.5 | 69 | 69.5 | 69 |
| Butylacrylate | — | — | — | — | — |
| [Monomer charged collectively at final] | | | | | |
| Styrene | 20 | 30 | 10 | 10 | 10 |
| Divinylbenzene | — | — | — | 10 | 10 |
| α-methylstyrene | — | — | — | — | — |
| Particle diameter (nm) | 810 | 890 | 750 | 810 | 820 |
| T_{g} of polymer constituting shell layer (° C.) | 104 | 104 | 104 | 110 | 110 |
| Polymerization stability (visual) | ◯ | ◯ | ◯ | ◯ | ⊚ |
| Hollow polymer particle X | X2-1 | X2-2 | X2-3 | X2-4 | X2-5 |
| Polymer particle B | B2-1 | B2-2 | B2-3 | B2-4 | B2-5 |
| Polymerization temperature of (b) when pH was | 80 | 90 | 80 | 85 | 85 |
| raised up (° C.) | | | | | |
| Unreacted monomer content when pH was raised | 9 | 20 | 5 | 11 | 11 |
| up (% by weight) | | | | | |
| Particle diameter after treating (nm) | 1100 | 1190 | 1100 | 1150 | 1160 |
| Inner hole diameter after treating (nm) | 960 | 1010 | 1060 | 1020 | 1030 |
| Volume percentage of hollowness (%) | 66 | 61 | 89 | 70 | 70 |
| Thickness of shell (nm) | 140 | 180 | 40 | 130 | 130 |
| Morphology with a microscope | | | | | |

| | |
|---|---|
| Shape | Spherical |
| Inner hole | Single hole |

TABLE 6-2

| | Example | | | | |
|---|---|---|---|---|---|
| | 2-6 | 2-7 | 2-8 | 2-9 | 2-10 |
| Polymer particle B | B2-6 | B2-7 | B2-8 | B2-9 | B2-10 |
| Used polymer particle A | A-1 | A-1 | A-1 | A-1 | A-1 |
| Amount of polymer particle A | 16 | 16 | 16 | 16 | 16 |
| Monomer (b-1) | | | | | |
| Acrylic acid | 0.5 | 0.5 | 0.5 | 0.5 | 0.5 |
| Itaconic acid | 0.5 | 0.5 | — | — | — |
| Monomer (b-2) | | | | | |
| [Monomer charged collectively at first] | | | | | |
| Methylmethacrylate | — | 10 | — | — | — |
| Styrene | — | 10 | 10 | 10 | 10 |
| [Continuously-added water-dispersion monomer] | | | | | |
| Styrene | 69.5 | 59.5 | 69.5 | 59.5 | 89.5 |
| Butylacrylate | — | — | — | 10 | — |
| [Monomer charged collectively at final] | | | | | |
| Styrene | 10 | 10 | 10 | 10 | — |
| Divinylbenzene | — | — | — | — | — |
| α-methylstyrene | 10 | 10 | 10 | 10 | — |
| Particle diameter (nm) | 810 | 810 | 810 | 810 | 810 |
| T_{g} of polymer constituting shell layer (° C.) | 107 | 107 | 107 | 107 | 104 |
| Polymerization stability (visual) | ◯ | ⊚ | ◯ | ⊚ | ◯ |
| Hollow polymer particle X | X2-6 | X2-7 | X2-8 | X2-9 | X2-10 |
| Polymer particle B | B2-6 | B2-7 | B2-8 | B2-9 | B2-10 |
| Polymerization temperature of (b) when pH was | 80 | 80 | 80 | 80 | 90 |
| raised up (° C.) | | | | | |
| Unreacted monomer content when pH was raised | 13 | 13 | 13 | 13 | 3 |
| up (% by weight) | | | | | |
| Particle diameter after treating (nm) | 1150 | 1180 | 1180 | 1180 | 1000 |
| Inner hole diameter after treating (nm) | 1030 | 1080 | 1070 | 1100 | 820 |
| Volume percentage of hollowness (%) | 72 | 77 | 75 | 81 | 55 |
| Thickness of shell (nm) | 120 | 100 | 110 | 80 | 180 |
| Morphology with a microscope | | | | | |

| | |
|---|---|
| Shape | Spherical |
| Inner hole | Single hole |

TABLE 6-3

| | Example | | | |
|---|---|---|---|---|
| | 2-11 | 2-12 | 2-13 | 2-14 |
| Polymer particle B | B2-11 | B2-12 | B2-13 | B2-14 |
| Used polymer particle A | A-1 | A-1 | A-1 | A-1 |
| Amount of polymer particle A | 16 | 10 | 10 | 5 |
| Monomer (b-1) | | | | |
| Acrylic acid | 0.5 | 0.5 | 0.5 | 0.5 |
| Itaconic acid | — | 0.5 | — | — |
| Monomer (b-2) | | | | |
| [Monomer charged collectively at first] | | | | |
| Methylmethacrylate | — | — | — | — |
| Styrene | 20 | 10 | 20 | 20 |
| [Continuously-added water-dispersion monomer] | | | | |
| Styrene | 69.5 | 79 | 69.5 | 49.5 |
| Butylacrylate | — | — | — | 20 |
| [Monomer charged collectively at final] | | | | |
| Styrene | 10 | 5 | 5 | 5 |
| Divinylbenzene | — | 5 | — | — |
| α-methylstyrene | — | — | 5 | 5 |
| Particle diameter (nm) | 800 | 830 | 830 | 850 |
| T_{g} of polymer constituting shell layer (° C.) | 104 | 110 | 104 | 75 |
| Polymerization stability (visual) | ◯ | ◯ | ◯ | ◯ |
| Hollow polymer particle X | X2-11 | X2-12 | X2-13 | X2-14 |
| Polymer particle B | B2-11 | B2-12 | B2-13 | B2-14 |
| Polymerization temperature of (b) when pH was | 80 | 80 | 90 | 80 |
| raised up (° C.) | | | | |
| Unreacted monomer content when ph was raised | 7 | 8 | 7 | 7 |
| up (% by weight) | | | | |
| Particle diameter after treating (nm) | 990 | 1100 | 1100 | 1150 |
| Inner hole diameter after treating (nm) | 830 | 820 | 800 | 890 |
| Volume percentage of hollowness (%) | 59 | 41 | 38 | 46 |
| Thickness of shell (nm) | 160 | 280 | 300 | 260 |
| Morphology with a microscope | | | | |

| | |
|---|---|
| Shape | Spherical |
| Inner hole | Single hole |

In Table 6, polymerization stability is evaluated as ◯, Δ and × according to the state that aggregates adhere to the reaction vessel and stirring fans.

◯; the amount of the aggregates was little,

Δ; the amount of the aggregates was somewhat large, and

×; the amount of the aggregates was large.

Average particle size, average inner hole diameter, volume percentage of hollowness, external form and form of inner hole of the obtained hollow polymer particle were evaluated by the method described above.

The average particle sizes of the hollow polymer particles X2-1 to X2-14 were 990 to 1,190 nm. The average inner hole diameters of the hollow polymer particles X2-1 to X2-14 were 800 to 1,100 nm. The volume percentages of hollowness of the hollow polymer particles X2-1 to X2-9 were 61 to 89% and X2-10 to X2-14 were 38 to 59%.

And all the hollow polymer particles X2-1 to X2-14 were spherical hollow particles each of which had a single hollow.

(4) Application to a Paper Coating Composition

Paper coating compositions prepared by the method described below were used to produce coated papers and properties were evaluated.

### Examples 2-1 to 2-12 and Comparative Examples 2-1 to 2-8

0.05% by weight of a dispersing agent (Trade name; “ARON T-40”, manufactured by Toagosei Co., Ltd.), and 0.2% by weight of sodium hydroxide were dissolved in water. While stirring a resultant solution with a Kores dispersing machine, inorganic pigments shown in Tables 7 and 8 were added to the solution. The inorganic pigments in Tables 7 and 8 were the same as the above-mentioned Example 1.

After the addition of the inorganic pigments, the dispersed product was stirred for 30 minutes. Thereto were further added each of the hollow polymer particles X2-1 to X2-14 shown in Tables 7 and 8, a copolymer latex having a solid content of 48% (Trade name; “JSR0619”, manufactured by JSR Corp.) and starch (Trade name; “MS-4600”, manufactured by Nippon Shokuhin Co., Ltd.) as the binder (Y), and a thickener (Trade name; “Modicol VD-S”, manufactured by Sannopco Co., Ltd.) at amounts shown in Tables 7 and 8. Water was added thereto in such a manner that the total solid content which is referred to as “color solid content”, would be a value shown in Tables 7 and 8. In this way, paper coating compositions were prepared. Each of values in parentheses in Tables 7 and 8 is amount in the case in which the total amount of the hollow polymer particle (X), the binder (Y), the pigment (Z) and the thickener (W) was set to 100 parts in terms of solid content.

Comparative Examples 2-1 to 2-5 were examples wherein the hollow polymer particles X2-10 to X2-14 having volume percentages of hollowness of less than 60% were used. Comparative Example 2-6 was an example wherein the content of the hollow polymer particle (X2) was less than 0.5 part by weight based on 100 parts by weight of the total amount of the hollow polymer particle (X2), the binder (Y), the pigment (Z) and the thickener (W) in terms of solid content (see Table 8). Further, Comparative Example 2-7 was an example wherein the content of the binder (Y) was less than 0.5 part by weight based on 100 parts by weight of the total amount of the hollow polymer particle (X2), the binder (Y), the pigment (Z) and the thickener (W) in terms of solid content (see Table 8).

### Comparative Example 2-9

A paper coating composition was prepared in the same way as in Examples 2-15 to 2-26 and Comparative examples 2-1 to 2-8 except that polymer particle which was not hollow (Trade name; “JSR0640”, manufactured by JSR Corp.) were used as a polymer particle.

### Comparative Example 2-10

A paper coating composition was prepared in the same way as in Examples 2-15 to 2-26 and Comparative examples 2-1 to 2-8 except that polymer particle having a volume percentage of hollowness of less than 60% (Trade name; “JSRAE850”, manufactured by JSR Corp.) was used as polymer particle.

TABLE 7-1

| | Example | | | | | | | |
|---|---|---|---|---|---|---|---|---|
| | 2-15 | | 2-16 | | 2-17 | | 2-18 | |
| Hollow polymer particle X | | | | | | | | |
| Component | X2-1 | | X2-2 | | X2-3 | | X2-4 | |
| Amount (parts) | 5 | (4.5) | 5 | (4.5) | 1 | (0.9) | 3 | (2.6) |
| Inorganic-based | | | | | | | | |
| pigment Z (parts) | | | | | | | | |
| First class clay | 35 | (31.2) | 35 | (31.3) | 39 | (33.9) | 27 | (23.1) |
| Second class clay | 30 | (26.7) | 30 | (26.8) | 30 | (26.0) | 0 | 0 |
| Calcium carbonate | 30 | (26.7) | 30 | (26.8) | 30 | (26.0) | 70 | (59.8) |
| Total | 95 | (84.7) | 95 | (84.8) | 99 | (85.9) | 97 | (82.9) |
| Total of X and Z (parts) | 100 | (89.1) | 100 | (89.3) | 100 | (86.8) | 100 | (85.5) |
| Binder Y (parts) | | | | | | | | |
| JSR0619 | 12 | (10.7) | 9 | (8.0) | 15 | (13.0) | 14 | (12.0) |
| Starch MS4600 | 0 | 0 | 3 | (2.7) | 0 | 0 | 3 | (2.6) |
| Total | 12 | (10.7) | 12 | (10.7) | 15 | 13.0 | 17 | (14.5) |
| Thickner (parts) | 0.2 | (0.2) | 0 | 0 | 0.2 | (0.2) | 0 | 0 |
| Modicol VD-S | | | | | | | | |
| Total of all (parts) | 112.2 | (100.0) | 112 | (100.0) | 115.2 | (100.0) | 117 | (100.0) |

| | | | | |
|---|---|---|---|---|
| Solid content of the color (%) | 60.0 | 55.0 | 60.0 | 55.0 |
| Coated amount (g/m²) | 10.0 | 15.0 | 10.0 | 7.0 |
| Physical properties of coated paper | | | | |
| Dry picking | 4.3 | 4.0 | 4.6 | 4.5 |
| Wet picking | 4.4 | 4.1 | 4.2 | 4.5 |
| Gloss | 78.3 | 77.1 | 80.4 | 76.4 |
| Printing gloss | 88.3 | 87.2 | 89.0 | 87.3 |
| Opacity | 92.2 | 92.0 | 91.9 | 92.1 |
| Whiteness | 84.4 | 84.2 | 83.1 | 84.3 |
| Oken-type smoothness | 3440 | 3350 | 3500 | 3300 |

TABLE 7-2

| | Example | | | | | | | |
|---|---|---|---|---|---|---|---|---|
| | 2-19 | | 2-20 | | 2-21 | | 2-22 | |
| Hollow polymer particle X | | | | | | | | |
| Component | X2-5 | | X2-6 | | X2-7 | | X2-8 | |
| Amount (parts) | 50 | (44.2) | 1 | (0.9) | 100 | (86.8) | 20 | (17.8) |
| Inorganic-based | | | | | | | | |
| pigment Z (parts) | | | | | | | | |
| First class clay | 0 | 0 | 39 | (34.8) | 0 | 0 | 20 | (17.8) |
| Second class clay | 0 | 0 | 30 | (26.7) | 0 | 0 | 30 | (26.7) |
| Calcium carbonate | 50 | (44.2) | 30 | (26.7) | 0 | 0 | 30 | (26.7) |
| Total | 50 | (44.2) | 99 | (88.2) | 0 | 0 | 80 | (71.3) |
| Total of X and Z (parts) | 100 | (88.4) | 100 | (89.1) | 100 | (86.8) | 100 | (89.1) |
| Binder Y (parts) | | | | | | | | |
| JSR0619 | 12 | (10.6) | 12 | (10.7) | 15 | (13.0) | 12 | (10.7) |
| Starch MS4600 | 1 | (0.9) | 0 | 0 | 0 | 0 | 0 | 0 |
| Total | 13 | (11.5) | 12 | (10.7) | 15 | (13.0) | 12 | (10.7) |
| Thickner (parts) | 0.1 | (0.1) | 0.2 | (0.2) | 0.2 | (0.2) | 0.2 | (0.2) |
| Modicol VD-S | | | | | | | | |
| Total of all (parts) | 113.1 | (100.0) | 112.2 | (100.0) | 115.2 | (100.0) | 112.2 | (100.0) |

| | | | | |
|---|---|---|---|---|
| Solid content of the color (%) | 45.0 | 62.0 | 23.0 | 55.0 |
| Coated amount (g/m²) | 3.0 | 19.0 | 1.0 | 5.0 |
| Physical properties of coated paper | | | | |
| Dry picking | 4.3 | 4.2 | 4.9 | 4.2 |
| Wet picking | 4.4 | 4.8 | 4.4 | 4.5 |
| Gloss | 82.9 | 78.4 | 75.4 | 78.9 |
| Printing gloss | 91.0 | 91.1 | 89.3 | 88.3 |
| Opacity | 94.2 | 92.0 | 91.7 | 92.9 |
| Whiteness | 84.3 | 83.2 | 85.2 | 84.6 |
| Oken-type smoothness | 4090 | 3400 | 3100 | 3460 |

TABLE 7-3

| | Example | | | | | | | |
|---|---|---|---|---|---|---|---|---|
| | 2-23 | | 2-24 | | 2-25 | | 2-26 | |
| Hollow polymer particle X | | | | | | | | |
| Component | X2-9 | | X2-1 | | X2-1 | | X2-3 | |
| Amount (parts) | 40 | (38.8) | 100 | (88.3) | 70 | (60.8) | 3 | (3.0) |
| Inorganic-based | | | | | | | | |
| pigment Z (parts) | | | | | | | | |
| First class clay | 10 | (9.7) | 0 | 0 | 0 | 0 | 0 | 0 |
| Second class clay | 0 | 0 | 0 | 0 | 0 | 0 | 0 | 0 |
| Calcium carbonate | 50 | (48.4) | 0 | 0 | 30 | (26.0) | 0 | 0 |
| Total | 60 | (58.1) | 0 | 0 | 30 | (26.0) | 0 | 0 |
| Total of X and Z (parts) | 100 | (96.9) | 100 | (88.3) | 100 | (86.8) | 3 | (3.0) |
| Binder Y (parts) | | | | | | | | |
| JSR0619 | 3 | (2.9) | 13 | (11.5) | 15 | (13.0) | 3 | (3.0) |
| Starch MS4600 | 0 | 0 | 0 | 0 | 0 | 0 | 96.8 | (96.8) |
| Total | 3 | (2.9) | 13 | (11.5) | 15 | 13.0 | 99.8 | (99.8) |
| Thickner (parts) | 0.2 | (0.2) | 0.2 | (0.2) | 0.2 | (0.2) | 0.2 | (0.2) |
| Modicol VD-S | | | | | | | | |
| Total of all (parts) | 103.2 | (100.0) | 113.2 | (100.0) | 115.2 | (100.0) | 103.0 | (100.0) |

| | | | | |
|---|---|---|---|---|
| Solid content of the color (%) | 65.0 | 23.0 | 30.0 | 30.0 |
| Coated amount (g/m²) | 19.0 | 1.0 | 6.0 | 10.0 |
| Physical properties of coated paper | | | | |
| Dry picking | 4.4 | 4.7 | 4.9 | 5.0 |
| Wet picking | 4.4 | 4.9 | 4.2 | 5.0 |
| Gloss | 83.0 | 76.4 | 83.9 | 75.1 |
| Printing gloss | 92.1 | 88.3 | 92.0 | 95.3 |
| Opacity | 92.4 | 91.9 | 93.7 | 90.0 |
| Whiteness | 83.1 | 85.1 | 84.4 | 82.9 |
| Oken-type smoothness | 4200 | 3300 | 4300 | 5800 |

TABLE 8-1

| | Comparative example | | | | | | | | | |
|---|---|---|---|---|---|---|---|---|---|---|
| | 2-1 | | 2-2 | | 2-3 | | 2-4 | | 2-5 | |
| Hollow polymer particle X | | | | | | | | | | |
| Component | X2-10 | | X2-11 | | X2-12 | | X2-13 | | X2-14 | |
| Amount (parts) | 5 | (4.5) | 5 | (4.5) | 5 | (4.5) | 5 | (4.5) | 5 | (4.5) |
| Inorganic-based | | | | | | | | | | |
| pigment Z (parts) | | | | | | | | | | |
| First class clay | 35 | (31.2) | 35 | (31.2) | 35 | (31.2) | 35 | (31.2) | 35 | (31.2) |
| Second class clay | 30 | (26.7) | 30 | (26.7) | 30 | (26.7) | 30 | (26.7) | 30 | (26.7) |
| Calcium carbonate | 30 | (26.7) | 30 | (26.7) | 30 | (26.7) | 30 | (26.7) | 30 | (26.7) |
| Total | 95 | (84.7) | 95 | (84.7) | 95 | (84.7) | 95 | (84.7) | 95 | (84.7) |
| Total of X and Z (parts) | 100 | (89.1) | 100 | (89.1) | 100 | (89.1) | 100 | (89.1) | 100 | (89.1) |
| Binder Y (parts) | | | | | | | | | | |
| JSR0619 | 12 | (10.7) | 12 | (10.7) | 12 | (10.7) | 12 | (10.7) | 12 | (10.7) |
| Starch MS4600 | 0 | 0 | 0 | 0 | 0 | 0 | 0 | 0 | 0 | 0 |
| Total | 12 | (10.7) | 12 | (10.7) | 12 | (10.7) | 12 | (10.7) | 12 | (10.7) |
| Thickner (parts) | 0.2 | (0.2) | 0.2 | (0.2) | 0.2 | (0.2) | 0.2 | (0.2) | 0.2 | (0.2) |
| Modicol VD-S | | | | | | | | | | |
| Total of all (parts) | 112.2 | (100.0) | 112 | (100.0) | 112.2 | (100.0) | 112.2 | (100.0) | 112 | (100.0) |

| | | | | | |
|---|---|---|---|---|---|
| Solid content of the color (%) | 60.0 | 60.0 | 60.0 | 60.0 | 60.0 |
| Coated amount (g/m²) | 10.0 | 10.0 | 10.0 | 10.0 | 10.0 |
| Physical properties of coated paper | | | | | |
| Dry picking | 4.3 | 4.2 | 4.3 | 4.4 | 4.3 |
| Wet picking | 4.4 | 4.3 | 4.4 | 4.2 | 4.4 |
| Gloss | 68.5 | 69.3 | 65.4 | 62.1 | 66.3 |
| Printing gloss | 75.3 | 76.3 | 72.3 | 70.3 | 73.3 |
| Opacity | 87.5 | 87.7 | 86.5 | 85.4 | 87.0 |
| Whiteness | 80.2 | 81.0 | 79.8 | 78.8 | 80.2 |
| Oken-type smoothness | 2890 | 2940 | 2790 | 2770 | 2800 |

TABLE 8-2

| | Comparative example | | | | | | | | | |
|---|---|---|---|---|---|---|---|---|---|---|
| | 2-6 | | 2-7 | | 2-8 | | 2-9 | | 2-10 | |
| Particle | | | | | | | | | | |
| Component | X2-1 | | X2-1 | | X2-1 | | JSR0640 | | JSRAE850 | |
| Amount (parts) | 0.5 | (0.4) | 100 | (99.4) | 100 | (88.3) | 5 | (4.5) | 5 | (4.5) |
| Inorganic-based | | | | | | | | | | |
| pigment Z (parts) | | | | | | | | | | |
| First class clay | 39.5 | (35.2) | 0 | 0 | 0 | 0 | 35 | (31.2) | 35 | (31.2) |
| Second class clay | 30 | (26.7) | 0 | 0 | 0 | 0 | 30 | (26.7) | 30 | (26.7) |
| Calcium carbonate | 30 | (26.7) | 0 | 0 | 0 | 0 | 30 | (26.7) | | |
| Total | 99.5 | (88.7) | 0 | 0 | 0 | 0 | 95 | (84.7) | 95 | (84.7) |
| Total of X and Z (parts) | 100 | (89.1) | 100 | (99.4) | 100 | (88.3) | 100 | (89.1) | 100 | (89.1) |
| Binder Y (parts) | | | | | | | | | | |
| JSR0619 | 12 | (10.7) | 0.4 | (0.4) | 13 | (11.5) | 12 | (10.7) | 12 | (10.7) |
| Starch MS4600 | 0 | 0 | 0 | 0 | 0 | 0 | 0 | 0 | 0 | 0 |
| Total | 12 | (10.7) | 0.4 | (0.4) | 13 | (11.5) | 12 | (10.7) | 12 | (10.7) |
| Thickner (parts) | 0.2 | (0.2) | 0.2 | (0.2) | 0.2 | (0.2) | 0.2 | (0.2) | 0.2 | (0.2) |
| Modicol VD-S | | | | | | | | | | |
| Total of all (parts) | 112.2 | (100.0) | 100.6 | (100.0) | 113.2 | (100.0) | 112 | (100.0) | 112.2 | (100.0) |

| | | | | | |
|---|---|---|---|---|---|
| Solid content of the color (%) | 62.0 | 23.0 | 23.0 | 60.0 | 60.0 |
| Coated amount (g/m²) | 19.0 | 1.0 | 0.2 | 10.0 | 10.0 |
| Physical properties of coated paper | | | | | |
| Dry picking | 4.5 | 1.5 | 5.0 | 4.6 | 4.2 |
| Wet picking | 4.8 | 1.6 | 5.0 | 4.8 | 4.9 |
| Gloss | 60.4 | 75.6 | 55.3 | 58.6 | 67.0 |
| Printing gloss | 68.3 | 78.2 | 62.8 | 67.3 | 75.3 |
| Opacity | 84.3 | 91.7 | 80.3 | 83.2 | 87.3 |
| Whiteness | 77.9 | 85.3 | 76.7 | 76.6 | 80.0 |
| Oken-type smoothness | 2710 | 3460 | 2520 | 2680 | 2820 |

\mathring{1} Production of Coated Paper

Commercially available fine paper [weighting capacity: 72 g/m2] was coated with each of the paper coating compositions of Examples 2-15 to 2-26 and Comparative examples 2-1 to 2-10 by means of the “Labo Curtain Coater” (Type; “Flow coater FL-S3G”, manufactured by Anest Iwata Co., Ltd.) at a coating speed of 100 m/s in such a manner that the coating amount after drying the composition would be a value shown in Tables 7 and 8, and then a resultant was dried at 150° C. in a gear oven for 3 seconds. A resultant single face coated paper was passed two times through the “Labo Super Calendar” (manufactured by Yuri Roll Corp.) having a roll surface temperature of 40° C. at a line pressure of 10N/m to yield a glossy coated paper. In Comparative example 2-8, the coating amount of the paper coating composition after drying was less than 0.3 g/m².

\mathring{2} Evaluation of the Coated Paper

The coated paper obtained in the item \mathring{1} was evaluated about dry picking strength, wet picking strength, gloss, printing gloss, whiteness, opacity and Oken type air-infiltration smoothness. The results are shown in Tables 7 and 8. The dry picking strength, wet picking strength, gloss, whiteness, opacity and Oken type air-infiltration smoothness were evaluated by the above-mentioned methods. The printing gloss was evaluated by the following method.

[Method of Evaluating the Printing Gloss]

An RI type printer was used to perform printing with a tack No. 5 ink. After the ink was dried, the gloss of the printed face was measured with a Murayama type gloss meter at an incident angle of 75 degrees and a reflection angle of 75 degrees. As the value is larger, the printing gloss is better.

(5) Effects of Examples 2-12 to 2-26 (Coated Paper)

In the case in which the polymer particles which were not hollow were used as polymer particles or the polymer particles having a volume percentage of hollowness of less than 60% were used (Comparative examples 2-1 to 2-5, 2-9 and 2-10), the following results were obtained: gloss; 58.6 to 68.5, printing gloss; 67.3 to 73.3, opacity: 83.2 to 87.7, and whiteness; 76.6 to 81.0. The respective properties were not sufficient.

In the case in which the amount of the pigment (Z) when the total amount of the binder (Y) (solid content), the pigment (Z) and the thickener (W) is set to 100 parts was less than 0.5 part (see Table 8), the following results were obtained: gloss; 60.4, printing gloss; 68.3, opacity; 84.3, and whiteness; 77.9. The respective properties were insufficient.

On the other hand, in the case in which the volume percentage of hollowness was 60% or more and the content of the hollow polymer particle was 0.5% or more (Comparative example 2-7, and Examples 2-15 to 2-26), the following results were obtained: gloss; 75.1 to 83.9, printing gloss; 78.2 to 95.3, opacity; 90.0 to 94.2, and whiteness; 82.9 to 85.2. The respective properties were superior.

Particularly, in the case in which the amount of the hollow polymer particle (X) is 40 to 70 parts and that of the pigment (Z) is 30 to 60 parts when the total amount of the hollow polymer particle (X) and the pigment (Z) is set to 100 parts (Examples 2-19, 2-23 and 2-25), the following results were obtained: gloss; 82.9 to 83.9, printing gloss 91.0 to 92.1, opacity; 92.4 to 94.2, and whiteness; 83.1 to 84.4. These performances and the balance thereof were very good.

Furthermore, in the case in which the amount of the binder (Y) is less than 0.5 part when the total amount of the binder (Y) (solid content), the pigment (Z) and the thickener (W) is set to 100 parts (Comparative example 2-7), a sufficient dry picking strength and a wet picking strength were not obtained. However, the amount of 0.5 part or more (Examples 2-15 to 2-26) shows excellent in dry picking strength of 4.0 to 5.0 and wet picking strength of 4.1 to 5.0, respectively.

Even if the amount was within the scope of the present invention, sufficient gloss, printing gloss, opacity and whiteness were not obtained when the coating amount was less than 0.3 g/m² (Comparative example 2-8). However, when the coating amount was 0.3 g/m² or more (Examples 2-15 to 2-26), the gloss, printing gloss, opacity and whiteness were superior.

What is claimed is:

1. A process for producing a hollow polymer particle, comprising:
a step of emulsion-polymerization, polymerizing monomers (a) comprising 5 to 80% by weight of an unsaturated carboxylic acid (a-1) and 20 to 95% by weight of a radical-polymerizable monomer (a-2) which can copolymerize with said unsaturated carboxylic acid (a-1) (provided that total amount of said (a-1) and said (a-2) is set to 100% by weight), thereby preparing a polymer particle (A),
a step of emulsion-polymerization, polymerizing a part of 100 parts by weight of monomers (b) comprising 0 to 20% by weight of an unsaturated carboxylic acid (b-1) and 80 to 100% by weight of a radical-polymerizable monomer (b-2) which can copolymerize with said unsaturated carboxylic acid (b-1) (provided that the total amount of said (b-1) and said (b-2) is set to 100% by weight) in the presence of 5 to 1,000 parts by weight of said polymer particle (A), thereby preparing a core/shell type polymer particle (B) wherein the surface of said polymer particle (A) is covered with a shell layer comprising a polymer component obtained by polymerizing a part of said monomers (b) and an unreacted monomer component of said monomers (b),
a step of adjusting pH of the dispersed product containing said polymer particle (B) to 7 or more with a volatile base, thereby neutralizing and swelling said polymer particle (B), and
a step of polymerizing said unreacted monomer component.

2. The process for producing a hollow polymer particle according to claim 1, wherein the weight ratio of said polymer component to said unreacted monomer component in said shell layer is from 99/1 to 50/50.

3. The process for producing a hollow polymer particle according to claim 1, wherein said shell layer is produced by charging a part or all of said monomers (b) which will be said polymer component collectively at first and then emulsion-polymerizing the charged monomers.

4. The process for producing a hollow polymer particle according to claim 3, wherein 50% or more by weight of said collectively-charged monomers (b) based on 100% by weight of the total of said monomers (b) is an unsaturated carboxylic acid ester and/or an ethylenic aromatic compound.

5. The process for producing a hollow polymer particle according to claim 3, wherein the weight ratio of said collectively-charged monomers (b) to said polymer particle (A) is from 10/1 to 1/10.

6. The process for producing a hollow polymer particle according to claim 1, wherein said radical-polymerizable monomer (b-2) comprises a crosslinkable radical-polymerizable monomer, and the content of said crosslinkable radical polymerizable monomer is 50% or less by weight based on 100% by weight of the total of said radical-polymerizable monomer (b-2).

7. The process for producing a hollow polymer particle according to claim 1, wherein temperature of said dispersed product when said polymer particle (B) is neutralized and swelled is set to not more than the glass transition temperature (Tg) of said polymer component.

8. The process for producing a hollow polymer particle according to claim 1, wherein when said emulsion-polymerization is carried out by polymerizing only said radical-polymerizable monomer (b-2), and polymerizing the rest of said radical-polymerizable monomer (b-2) and said unsaturated carboxylic acid (b-1) after the completion of polymerization of 10 to 35% by weight of said monomers (b-2).

9. A hollow polymer particle produced by a process according to claim 1.

10. The hollow polymer particle according to claim 9, wherein volume percentage of hollowness is 50 to 99%.

11. A paper coating composition, comprising 0.1 to 100 parts by weight of the hollow polymer particle (X) according to claim 9, and 0 to 99.9% by weight of a pigment (Z) and/or a binder (Y) based on 100% by weight of the total amount of said (X), (Y) and (Z).

12. The paper coating composition according to claim 11, wherein volume percentage of hollowness of said hollow polymer particle (X) is 50 to 99%.

13. A paper coating composition, comprising a hollow polymer particle having a volume percentage of hollowness of 50 to 99% and an average particle size of 300 to 5,000 nm.

14. The paper coating composition according to claim 14, wherein thickness of shell of said hollow polymer particle is 30 to 200 nm.

15. The paper coating composition according to claim 13, wherein said hollow polymer particle is the hollow particle according to claim 9.

16. The paper coating composition according to claim 13, comprising 0.5 to 99.5% by weight of said hollow polymer particle, 0.5 to 99.5% by weight of a binder, and 0 to 99% by weight of a pigment and/or a thickener in terms of solid content based on 100% by weight of the total components.

17. A coated paper comprising a base paper and a coating which is formed on a single surface or both surfaces of said base paper and comprised of a hollow polymer particle and a binder, which is characterized in that volume percentage of hollowness of said hollow polymer particle is 50 to 99% and an average particle size of 300 to 5,000 nm.

18. A process for producing a coated paper characterized in coating the paper coating composition according to claim 13 to a base paper in the manner that the coating amount of said composition is 0.3 to 30 g/m² after drying the composition.
